(19) United States
(12) Patent Application Publication
(10) Pub. No.: US 2026/0238389 A1
(43) Pub. Date: Aug. 13, 2026

(54) Method for Multiple CG PUSCH Transmissions

(71) Applicant: Telefonaktiebolaget LM Ericsson (publ), Stockholm (SE)

(72) Inventors: Bikramjit Singh, Raasepori (FI); Jonas Fröberg Olsson, Ljungsbro (SE); Sorour Falahati, Stockholm (SE); Robert Karlsson, Sundbyberg (SE)

(21) Appl. No.: 19/155,612

(22) PCT Filed: Feb. 16, 2024
(86) PCT No.: PCT/SE2024/050153

§ 371 Date: Aug. 12, 2025

Related U.S. Application Data
(60) Provisional application No. 63/446,749, filed on Feb. 17, 2023.

(51) Int. Cl. H04L 1/1812; H04W 72/0446; H04W 72/231; H04W 76/20

(52) U.S. Cl. CPC H04L 1/1812; H04W 72/0446; H04W 72/231; H04W 76/20

(57) ABSTRACT

Techniques are provided for the retransmission of data packets over multiple or group Physical Uplink Shared Channels (PUSCHs) using dynamic grant Downlink Control Information (DCI) scrambled or encoded with a Configured Scheduling-Radio Network Temporary Identifier (CS-RNTI). The techniques described herein configure a network node (20) that allocates time-frequency resources to a User Equipment (UE) (30) for the retransmissions to reschedule multiple retransmissions using a single DCI scrambled with CS-RNTI.

### TECHNICAL FIELD

The present disclosure relates generally to scheduling in a communication network, and more particularly, to scheduling the retransmission of data by User Equipment (UE) over multiple shared uplink channels.

### BACKGROUND

The ConfiguredGrantConfig is an Information Element (IE) used to configure uplink transmissions without a dynamic grant according to two possible schemes—Type 1 and Type 2. With Type 1, the actual uplink grant is configured via Radio Resource Control (RRC). With Type 2, the uplink grant is provided via the Physical Downlink Control Channel (PDCCH) and addressed to a Configured Scheduling-Radio Network Temporary Identifier (CS-RNTI) (i.e., Type2).

For both Type 1 and Type 2 CGs, network nodes provide UEs with the time-frequency resources on which they are allowed to transmit on the Physical Uplink Shared Channel (PUSCH). Such time-frequency resources are typically referred to as Transmission Occasions (TOs). In conventional systems, the network nodes inform the UEs of the allocated time-frequency resources for each retransmission using Downlink Control Information (DCI) that has been scrambled or encoded with CS-RNTI. However, conventional systems using DCI scrambled or encoded with CS-RNTI only allow retransmissions by a UE on a single PUSCH. This restriction negatively impacts user traffic requiring low latency because there may not be enough time to schedule separate retransmissions for a UE using separate DCIs.

### SUMMARY

Embodiments of the present disclosure provide a system and method for scheduling the retransmission of data packets over multiple or group Physical Uplink Shared Channels (PUSCHs) using dynamic grant Downlink Control Information (DCI) scrambled or encoded with a Configured Scheduling-Radio Network Temporary Identifier (CS-RNTI).

More particularly, a first aspect of the present disclosure provides a method, implemented at a User Equipment (UE), for scheduling retransmissions in a communications network. In this aspect, the UE transmits, to a network node, a first transport block (TB) on a first shared uplink channel associated with a first Hybrid Automatic Repeat Request (HARQ) process (HP), and a second TB on a second shared uplink channel different from the first shared uplink channel. Each of the first and second shared uplink channels are associated with respective, different HPs. The UE then receives, from the network node, in a single scheduling Downlink Control Information (DCI), one or more resource allocations for retransmission of the first and second TBs by the UE, and retransmits, to the network node, the first and second TBs using the allocated resources indicated in the single scheduling DCI.

A second aspect of the present disclosure provides a method, implemented at a network node, for scheduling retransmissions in a communications network. In this aspect, the network node receives, from a UE, a first TB on a first shared uplink channel associated with a first HP, and a second TB on a second shared uplink channel. The first and second shared uplink channels are different from each other, and each is associated with respective, different HPs. The network node then transmits, to the UE, one or more resource allocations for retransmission of the first and second TBs by the UE in a single scheduling DCI, and subsequently receives, from the UE, the first and second retransmitted TBs on the allocated resources indicated in the single scheduling DCI.

A third aspect of the present disclosure provides a UE configured to retransmit data on multiple uplink shared channels according to a Configured Grant (CG). In this aspect, the UE comprises processing circuitry and memory circuitry configured to store instructions executable by the processing circuitry. When executed, the instructions configure the UE to transmit, to a network node, a first TB on a first shared uplink channel associated with a first HP and a second TB on a second shared uplink channel different from the first shared uplink channel. The first and second shared uplink channels are each associated with respective, different HPs. The instructions also configure the UE to receive, from the network node, in a single scheduling DCI, one or more resource allocations for retransmission of the first and second TBs by the UE, and retransmit, to the network node, the first and second TBs using the allocated resources indicated in the single scheduling DCI.

A fourth aspect of the present disclosure provides a UE for retransmitting data on multiple uplink shared channels according to a CG. In this aspect, the UE is configured to transmit, to a network node, a first TB on a first shared uplink channel associated with a first HP, transmit, to the network node, a second TB on a second shared uplink channel different from the first shared uplink channel, and associated with a second HP different from the first HP, receive, from the network node, in a single scheduling DCI, one or more resource allocations for retransmission of the first and second TBs by the UE, and retransmit, to the network node, the first and second TBs using the allocated resources indicated in the single scheduling DCI.

In a fifth aspect, the present disclosure provides a computer program comprising instructions stored thereon that, when executed on processing circuitry of a UE, cause the UE to perform the method according to the first aspect.

In a sixth aspect, the present disclosure provides a carrier containing the computer program of the fifth aspect. The carrier is one of an electronic signal, optical signal, radio signal, or computer readable storage medium.

In a seventh aspect, a non-transitory computer-readable storage medium comprises a computer program stored thereon. The computer program comprises executable instructions that, when executed by a processing circuit in a UE, causes the UE to perform the method according to the first aspect.

An eighth aspect of the present disclosure provides a network node for scheduling retransmissions in a communications network. In this aspect, the network node comprises processing circuitry and memory circuitry configured to store instructions executable by the processing circuitry. When executed, the instructions configure the network node to receive, from a UE, a first TB on a first shared uplink channel associated with a first HP, receive, from the UE, a second TB on a second shared uplink channel different from the first shared uplink channel and associated with a second HP different from the first HP, transmit, to the UE, one or more resource allocations for retransmission of the first and second TBs by the UE in a single scheduling DCI, and receive, from the UE, the first and second retransmitted TBs on the allocated resources indicated in the single scheduling DCI.

A ninth aspect of the present disclosure provides a network node for scheduling retransmissions in a communications network. The network node is configured to receive, from a UE, a first TB on a first shared uplink channel associated with a first HP, receive, from the UE, a second TB on a second shared uplink channel different from the first shared uplink channel and associated with a second HP different from the first HP, transmit, to the UE, one or more resource allocations for retransmission of the first and second TBs by the UE in a single scheduling DCI, and receive, from the UE, the first and second retransmitted TBs on the allocated resources indicated in the single scheduling DCI.

A tenth aspect provides a computer program comprising instructions stored thereon that, when executed on processing circuitry of a network node, cause the network node to perform the method according to the second aspect.

In an eleventh aspect, the present disclosure provides a carrier containing the computer program of the tenth aspect. The carrier is one of an electronic signal, optical signal, radio signal, or computer readable storage medium.

In a twelfth aspect, a non-transitory computer-readable storage medium comprises a computer program stored thereon. The computer program comprises executable instructions that, when executed by a processing circuit in a UE, causes the UE to perform the method according to the second aspect.

### BRIEF DESCRIPTION OF THE DRAWINGS

FIG. 1 illustrates a communication network configured according to an embodiment of the present disclosure.

FIG. 2 illustrates a timeline constraint between PDCCH with DCI format dynamically scheduling a PUSCH when an overlapping CG PUSCH is absent (top) or present (bottom).

FIG. 3 is a signaling diagram illustrating signaling between a network node and a User Equipment (UE) according to an embodiment of the present disclosure.

FIG. 4 is a flow diagram illustrating a method for scheduling retransmissions in a communications network according to an embodiment of the present disclosure.

FIG. 5 is a flow diagram illustrating a method for scheduling retransmissions in a communications network according to another embodiment of the present disclosure.

FIG. 6 illustrates an exemplary UE configured for retransmitting Transport Blocks (TBs) to a network node according to an embodiment of the present disclosure.

FIG. 7 illustrates an exemplary network node configured for scheduling the retransmission of Transport Blocks (TBs) by a UE according to an embodiment of the present disclosure.

FIG. 8 shows an example of a communication system in accordance with some embodiments.

FIG. 9 is a block diagram of a host in accordance with various aspects described herein.

FIG. 10 shows a communication diagram of a host communicating via a network node with a UE over a partially wireless connection in accordance with some embodiments.

### DETAILED DESCRIPTION

The following terms are used throughout the specification.

Particularly, a Configured Grant (CG) with multiple Physical Uplink Shared Channels (PUSCHs) per period may be referred to herein as “multi-PUSCH CG,” “multi-HARQ CG,” “multi-TB CG,” “multi-occasion CG,” “multi-slot CG,” or “multi-Start and Length Indicator Value SLIV CG.”

A CG “period” is defined herein as the time duration or window indicated by a periodicity parameter in a ConfiguredGrantConfig (Information Element (IE).

A CG with a single PUSCH per period may be referred to herein as a “single-PUSCH CG,” “single-HARQ CG,” “single-TB CG,” “single-occasion CG,” “single-slot CG,” “single-SLIV CG,” or in cases where a CG-retransmission timer is not configured, “legacy CG.”

The term PUSCH can used interchangeably with “Hybrid Automatic Repeat Request (HARQ) process” or SLIV,” or “Transport Block (TB).”

When multiple ConfiguredGrantConfiguration IEs are configured, one of them may be referred to herein as CG C1 and another may be referred to as CG C2.

In at least some embodiments described herein, the New Data Indicator (NDI) bitfield may be indicated as bit strings (e.g., NDI=‘1010’) without an underlying assumption on how the bit string is mapped to the bitfield in the DCI. The same holds for the Redundancy Version (RV) bitfield. Additionally, the actual field sizes for NDI or RV in the DCI may be larger than the number of bits that carry information. For example, consider an NDI bitfield in the DCI consists of 6 bits [d1, d2, . . . , d6], where d1 is the Most Significant Bit (MSB). Further assume that the NDI bitfield has a value of ‘1011’. In some embodiments, the bits that are set to ‘1’ in the NDI bitfield are associated with certain SLIVs and/or PUSCH transmissions, and/or are used to map to a HARQ process (HP) Identifier (ID). Additionally, the bit string ‘1011’ can be mapped to the NDI bitfield as either [x, x, 1, 0, 1, 1] or [x, x, 1, 1, 0, 1], or [1, 1, 0, 1, x, x], or [1, 0, 1, 1, x, x], etc., where an ‘x’ indicates a bit that does not carry information.

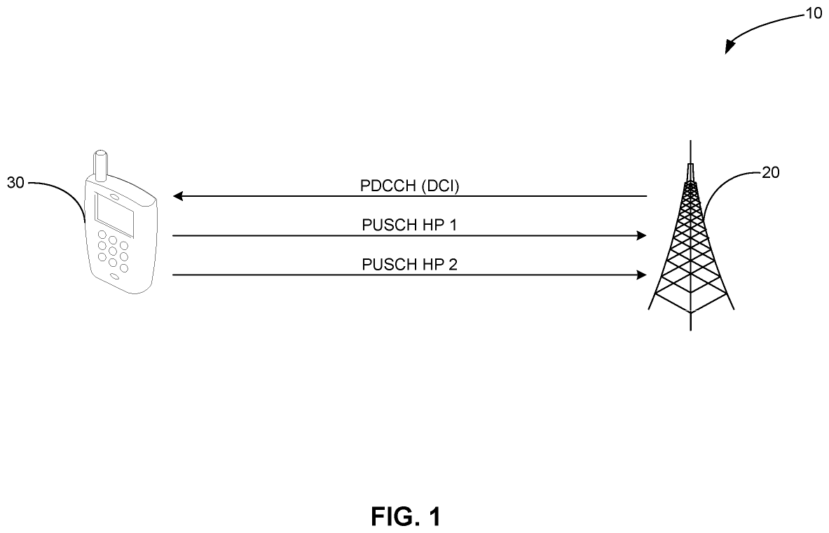

Turning now to the drawings, FIG. 1 illustrates a communication network 10 comprising a Radio Access Network (RAN) node 20 (e.g., a gNB) and User Equipment (UE) 30. The RAN node 20 and UE 30 communicate with each other over an air interface, as is known in the art. To effect such communications, RAN node 20 provides UE 30 with DCI encoded with CS-RNTI (hereinafter referred to as “encoded DCI”) over a Physical Downlink Control Channel (PDCCH). The encoded DCI may be provided to the UE for initial transmissions of data packets (e.g., Transport Blocks (TBs)), as well as dynamically for the retransmission of those TBs by UE 30.

The encoded DCI indicates the resources (e.g., the PUSCH or PUSCHs) on which UE 30 is to transmit/retransmit its data to RAN node 20. Each PUSCH is associated with a corresponding HARQ process (HP), identified by a HP ID, with the HPs for retransmissions being the same as those for the initial transmissions. In this embodiment, UE 30 is configured for multi-PUSCH. Therefore, UE 30 sends its TBs to RAN node 20 via PUSCH HP 1 and PUSCH HP 2.

As previously stated, a ConfiguredGrantConfig IE is used to configure uplink transmissions without a dynamic grant according to two possible schemes. Type 1 grants are configured via RRC signaling, while Type 2 grants are provided via the PDCCH and addressed to the CS-RNTI. Multiple CG configurations may be configured in one Bandwidth Part (BWP) of a serving cell. For both Type 1 and Type 2 CGs, UEs are provided with the time-frequency resources, referred to herein as Transmission Occasions (TOs), on which it is allowed to transmit PUSCH data.

In more detail, the time-frequency resources for Type 1 CGs are indicated in a RRC message using timeDomainAllocation, frequencyDomainAllocation, and periodicity, together with a time reference to the slot in which the TO is located. The periodicity indicates recurrence of the TOs. The timeDomainAllocation indicates the first symbol of the PUSCH and the duration of the PUSCH (in symbols), and the frequencyDomainAllocation indicates the Resource Blocks (RBs) used by the PUSCH. For example, consider a situation where timeDomainAllocation indicates startSymbol=0 and endSymbol=14. This means that the PUSCH starts in the first symbol of the slot and ends in the last symbol. If the time reference indicates that the first TO is in slot 4, and that the periodicity is 5 slots, the TOs for the CG would be in slots 4, 9, 14, 19, 24, . . . and so on. Once the UE has been configured with a Type 1 CG, the UE may or may not transmit a PUSCH on the TOs for the CG until the UE receives a RRC message disabling the CG.

Type 2 CGs are more flexible than Type 1 CGs in which a UE is provided with the periodicity of the CG in the RRC message. Particularly, with Type 2 CGs, timeDomainAllocation and frequencyDomainAllocation are provided via the PDCCH, which simultaneously activates the CG. Together, the timeDomainAllocation and frequencyDomainAllocation provide the time reference for the first TO when the activation DCI on the PDCCH is sent to UE. Type 2 CGs can be deactivated by a deactivation DCI on a PDCCH.

The following table illustrates a ConfiguredGrantConfig IE.

-- ASN1START
-- TAG-CONFIGUREDGRANTCONFIG-START

| | |
|---|---|
| ConfiguredGrantConfig ::= | SEQUENCE { |
| frequencyHopping | ENUMERATED {intraSlot, interSlot} |

OPTIONAL, -- Need S

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED {sym2, sym7, sym1x14, sym2x14, |

```
        sym4x14, sym5x14, sym8x14, sym10x14, sym16x14, sym20x14, sym32x14, sym40x14,
        sym64x14, sym80x14, sym128x14, sym160x14, sym256x14, sym320x14, sym512x14,
        sym640x14, sym1024x14, sym1280x14, sym2560x14, sym5120x14, sym6, sym1x12,
        sym2x12, sym4x12, sym5x12, sym8x12, sym10x12, sym16x12, sym20x12, sym32x12,
        sym40x12, sym64x12, sym80x12, sym128x12, sym160x12, sym256x12, sym320x12,
        sym512x12, sym640x12, sym1280x12, sym2560x12
  },
```

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs- |

```
        1),
      ...,
  [[
```

| | |
|---|---|
| pusch-RepTypeIndicator-r16 | ENUMERATED {pusch-RepTypeA,pusch-RepTypeB} |

OPTIONAL, -- Need M

| | |
|---|---|
| frequencyHoppingPUSCH-RepTypeB-r16 | ENUMERATED {interRepetition, interSlot} |

OPTIONAL, -- Cond RepTypeB

| | |
|---|---|
| timeReferenceSFN-r16 | ENUMERATED {sfn512} |

```
OPTIONAL -- Need S
  ]],
  [[
```

| | |
|---|---|
| pathlossReferenceIndex2-r17 | INTEGER (0..maxNrofPUSCH-PathlossReferenceRSs- |

1)
OPTIONAL, -- Need R

| | |
|---|---|
| srs-ResourceIndicator2-r17 | INTEGER (0..15) |
| OPTIONAL, -- Need R | |
| precodingAndNumberOfLayers2-r17 | INTEGER (0..63) |
| OPTIONAL, -- Need R | |
| timeDomainAllocation-v1710 | INTEGER (16..63) |
| OPTIONAL, -- Need M | |
| timeDomainOffset-r17 | INTEGER (0..40959) |
| OPTIONAL, -- Need R | |
| cg-SDT-Configuration-r17 | CG-SDT-Configuration-r17 |

```
OPTIONAL -- Need M
          ]]
    }
OPTIONAL, -- Need R
  ...,
  [[
```

| | |
|---|---|
| cg-RetransmissionTimer-r16 | INTEGER (1..64) |

OPTIONAL, -- Need R

| | |
|---|---|
| cg-minDFI-Delay-r16 | ENUMERATED {sym7, sym1x14, sym2x14, sym3x14, |

```
        sym4x14, sym5x14, sym6x14, sym7x14, sym8x14, sym9x14, sym10x14, sym11x14,
        sym12x14, sym13x14, sym14x14,sym15x14, sym16x14}
OPTIONAL, -- Need R
```

| | |
|---|---|
| cg-nrofPUSCH-InSlot-r16 | INTEGER (1..7) |

OPTIONAL, -- Need R

| | |
|---|---|
| cg-nrofSlots-r16 | INTEGER (1..40) |

OPTIONAL, -- Need R

| | |
|---|---|
| cg-StartingOffsets-r16 | CG-StartingOffsets-r16 |

OPTIONAL, -- Need R

| | |
|---|---|
| cg-UCI-Multiplexing-r16 | ENUMERATED {enabled} |

OPTIONAL, -- Need R

| | |
|---|---|
| cg-COT-SharingOffset-r16 | INTEGER (1..39) |

OPTIONAL, -- Need R

| | |
|---|---|
| betaOffsetCG-UCI-r16 | INTEGER (0..31) |

OPTIONAL, -- Need R

| | |
|---|---|
| cg-COT-SharingList-r16 | SEQUENCE (SIZE (1..1709)) OF CG-COT-Sharing-r16 |

OPTIONAL, -- Need R

| | |
|---|---|
| harq-ProcID-Offset-r16 | INTEGER (0..15) |

OPTIONAL, -- Need M

| | |
|---|---|
| harq-ProcID-Offset2-r16 | INTEGER (0..15) |

OPTIONAL, -- Need M

| | |
|---|---|
| configuredGrantConfigIndex-r16 | ConfiguredGrantConfigIndex-r16 |

OPTIONAL, --Cond CG-List

| | |
|---|---|
| configuredGrantConfigIndexMAC-r16 | ConfiguredGrantConfigIndexMAC-r16 |

OPTIONAL, -- Cond CG-IndexMAC

| | |
|---|---|
| periodicityExt-r16 | INTEGER (1..5120) |

OPTIONAL, -- Need R

| | |
|---|---|
| startingFromRV0-r16 | ENUMERATED {on, off} |
| OPTIONAL, -- Need R | |
| phy-PriorityIndex-r16 | ENUMERATED {p0, p1} |
| OPTIONAL, -- Need R | |
| autonomousTx-r16 | ENUMERATED {enabled} |

```
OPTIONAL -- Cond LCH-BasedPrioritization
  ]],
  [[
```

| | |
|---|---|
| cg-betaOffsetsCrossPri0-r17 | SetupRelease { BetaOffsetsCrossPriSelCG-r17 } |

OPTIONAL, -- Need M

| | |
|---|---|
| cg-betaOffsetsCrossPri1-r17 | SetupRelease { BetaOffsetsCrossPriSelCG-r17 } |

OPTIONAL, -- Need M

| | |
|---|---|
| mappingPattern-r17 | ENUMERATED {cyclicMapping, sequentialMapping} |

OPTIONAL, -- Cond SRSsets

| | |
|---|---|
| sequenceOffsetForRV-r17 | INTEGER (0..3) |

OPTIONAL, -- Need R

| | |
|---|---|
| p0-PUSCH-Alpha2-r17 | P0-PUSCH-AlphaSetId |

OPTIONAL, -- Need R

| | |
|---|---|
| powerControlLoopToUse2-r17 | ENUMERATED {n0, n1} |

OPTIONAL, -- Need R

| | |
|---|---|
| cg-COT-SharingList-r17 | SEQUENCE (SIZE (1..50722)) OF CG-COT-Sharing-r17 |

OPTIONAL, -- Need R

| | |
|---|---|
| periodicityExt-r17 | INTEGER (1..40960) |

OPTIONAL, -- Need R

| | |
|---|---|
| repK-v1710 | ENUMERATED {n12, n16, n24, n32} |

OPTIONAL, -- Need R

| | |
|---|---|
| nrofHARQ-Processes-v1700 | INTEGER(17..32) |

OPTIONAL, -- Need M

| | |
|---|---|
| harq-ProcID-Offset2-v1700 | INTEGER (16..31) |

OPTIONAL, -- Need R

| | |
|---|---|
| configuredGrantTimer-v1700 | INTEGER(33..288) |

OPTIONAL, -- Need R

| | |
|---|---|
| cg-minDFI-Delay-v1710 | INTEGER (238..3584) |

OPTIONAL -- Need R
]]
}
CG-UCI-OnPUSCH ::= CHOICE {

| | |
|---|---|
| dynamic | SEQUENCE (SIZE (1..4)) OF BetaOffsets, |
| semiStatic | BetaOffsets |

}
CG-COT-Sharing-r16 ::= CHOICE {

| | |
|---|---|
| noCOT-Sharing-r16 | NULL, |
| cot-Sharing-r16 | SEQUENCE { |
| duration-r16 | INTEGER (1..39), |
| offset-r16 | INTEGER (1..39), |
| channelAccessPriority-r16 | INTEGER (1..4) |

}
}
CG-COT-Sharing-r17 ::= CHOICE {

| | |
|---|---|
| noCOT-Sharing-r17 | NULL, |
| cot-Sharing-r17 | SEQUENCE { |
| duration-r17 | INTEGER (1..319), |
| offset-r17 | INTEGER (1..319) |

}
}
CG-StartingOffsets-r16 ::= SEQUENCE {

| | |
|---|---|
| cg-StartingFullBW-InsideCOT-r16 | SEQUENCE (SIZE (1..7)) OF INTEGER (0..6) |

OPTIONAL, -- Need R

| | |
|---|---|
| cg-StartingFullBW-OutsideCOT-r16 | SEQUENCE (SIZE (1..7)) OF INTEGER (0..6) |

OPTIONAL, -- Need R

| | |
|---|---|
| cg-StartingPartialBW-InsideCOT-r16 | INTEGER (0..6) |

OPTIONAL, -- Need R

| | |
|---|---|
| cg-StartingPartialBW-OutsideCOT-r16 | INTEGER (0..6) |

OPTIONAL -- Need R
}
BetaOffsetsCrossPriSelCG-r17 ::= CHOICE {

| | |
|---|---|
| dynamic-r17 | SEQUENCE (SIZE (1..4)) OF BetaOffsetsCrossPri-r17, |
| semiStatic-r17 | BetaOffsetsCrossPri-r17 |

}
CG-SDT-Configuration-r17 ::= SEQUENCE {

| | |
|---|---|
| cg-SDT-RetransmissionTimer | INTEGER (1..64) |

OPTIONAL, -- Need R

| | |
|---|---|
| sdt-SSB-Subset-r17 | CHOICE { |
| shortBitmap-r17 | BIT STRING (SIZE (4)), |
| mediumBitmap-r17 | BIT STRING (SIZE (8)), |
| longBitmap-r17 | BIT STRING (SIZE (64)) |

}
OPTIONAL, -- Need S

| | |
|---|---|
| sdt-SSB-PerCG-PUSCH-r17 | ENUMERATED {oneEighth, oneFourth, half, one, |

two, four, eight, sixteen}
OPTIONAL, -- Need M

| | |
|---|---|
| sdt-P0-PUSCH-r17 | INTEGER (−16..15) |

OPTIONAL, -- Need M

| | |
|---|---|
| sdt-Alpha-r17 | ENUMERATED {alpha0, alpha04, alpha05, alpha06, |

alpha07, alpha08, alpha09, alpha1}
OPTIONAL, -- Need M

| | |
|---|---|
| sdt-DMRS-Ports-r17 | CHOICE { |
| dmrsType1-r17 | BIT STRING (SIZE (8)), |
| dmrsType2-r17 | BIT STRING (SIZE (12)) |

}
OPTIONAL, -- Need M

| | |
|---|---|
| sdt-NrofDMRS-Sequences-r17 | INTEGER (1..2) |

OPTIONAL -- Need M
}
-- TAG-CONFIGUREDGRANTCONFIG-STOP
-- ASN1STOP

### Timing and Slot Format Indicator Restrictions

Section 6.1 of the 3GPP specification TS 38.214, v17.4.0, which is incorporated herein by reference in its entirety, states that the timing restrictions for PUSCHs scheduled by PDCCH can override a PUSCH with a CG. Specifically, Section 6.1 states:
A UE is not expected to be scheduled by a PDCCH ending in symbol i to transmit a PUSCH on a given serving cell for a given HARQ process, if there is a transmission occasion where the UE is allowed to transmit a PUSCH with configured grant according to [10, TS 38.321] with the same HARQ process on the same serving cell starting in a symbol j after symbol i, and if the gap between the end of PDCCH and the beginning of symbol j is less than N₂ symbols. The value N₂ in symbols is determined according to the UE processing capability defined in clause 6.4, and N₂ and the symbol duration are based on the minimum of the subcarrier spacing corresponding to the PUSCH with configured grant and the subcarrier spacing of the PDCCH scheduling the PUSCH.

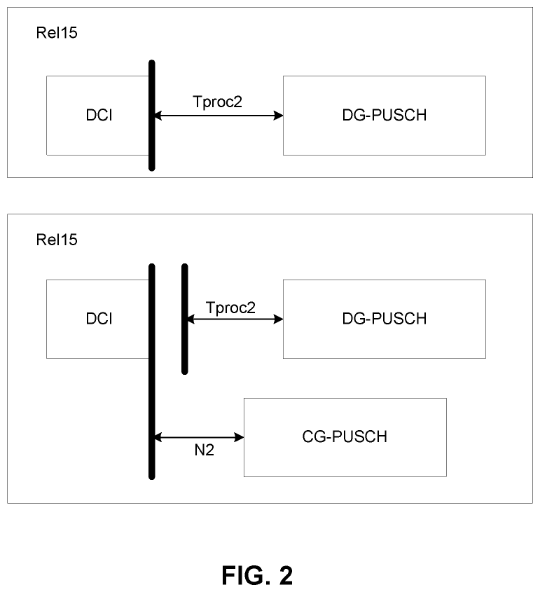

FIG. 2 shows the timeline constraint between the PDCCH with DCI format dynamically scheduling a PUSCH when an overlapping CG PUSCH is absent (top) or present (bottom).

Clause 11.1.1 of TS 38.213 v17.5.0, which is incorporated herein by reference in its entirety, places restrictions on the Slot Format Indicator (SFI) index if a UE is configured with CG Type 2 and the configured grant is activated. Specifically, Clause 11.1.1 states:
[A] UE does not expect to detect an SFI-index field value in DCI format 2_0 indicating the set of symbols of the slot as downlink or flexible if the set of symbols of the slot includes symbols corresponding to any repetition of a PUSCH transmission activated by an UL Type 2 grant PDCCH as described in clause 10.2.

Clause 11.1 (and Clause 11.1.1) in TS 38.213, also place restrictions for full or partial cancellation of a configured PUSCH if the UE detects a DCI format, which indicates to the UE to receive CSI-RS or PDSCH on the set of symbols including the configured grant PUSCH. Particularly:
For operation on a single carrier in unpaired spectrum, if a UE is configured by higher layers to transmit SRS, or PUCCH, or PUSCH, or PRACH in a set of symbols of a slot and the UE detects a DCI format indicating to the UE to receive CSI-RS or PDSCH in a subset of symbols from the set of symbols, then
   If the UE does not indicate the capability of [partialCancellation], the UE does not expect to cancel the transmission of the PUCCH or PUSCH or PRACH in the set of symbols if the first symbol in the set occurs within T_{prez,2} relative to a last symbol of a CORESET where the UE detects the DCI format; otherwise, the UE cancels the PUCCH, or the PUSCH, or an actual repetition of the PUSCH [6, TS 38.214], determined from clauses 9, 9.2.5 and 9.2.6 or clause 6.1 of [6, TS 38.214], or the PRACH transmission in the set of symbols.
   If the UE indicates the capability of [partialCancellation], the UE does not expect to cancel the transmission of the PUCCH or PUSCH or PRACH in symbols from the set of symbols that occur within T_{prez,2} relative to a last symbol of a CORESET where the UE detects the DCI format. The UE cancels the PUCCH, or the PUSCH, or an actual repetition of the PUSCH [6, TS 38.214], determined from clauses 9, 9.2.5 and 9.2.6 or clause 6.1 of [6, TS 38.214], or the PRACH transmission in remaining symbols from the set of symbols.
   The UE does not expect to cancel the transmission of SRS in symbols from the subset of symbols that occur within T_{prez,2} relative to a last symbol of a CORESET where the UE detects the DCI format. The UE cancels the SRS transmission in remaining symbols from the subset of symbols.
      T_{prez,2} is the PUSCH preparation time for the corresponding UE processing capability [6, TS 38.214] assuming and μ corresponds to the smallest SCS configuration between the SCS configuration of the PDCCH carrying the DCI format and the SCS configuration of the SRS, PUCCH, PUSCH or μᵣ, where μᵣ corresponds to the SCS configuration of the PRACH if it is 15 kHz or higher; otherwise μᵣ=0.

### CG-UCI (Section 6.3.2.1.3 in TS 38.212 V17.4.0 (2022-12)

For CG-UCI bits transmitted on a CG PUSCH when the higher layer parameter cg-Retransmission Timer is configured, the CG-UCI bit sequence a₀, a₁, a₂, a₃, . . . , a_{A-1} is determined as specified in Section 6.3.2.1.3 of TS 38.212 V17.4.0 (2022 December), which is incorporated herein by reference in its entirety. Specifically:

$$set \text{?} = {\tilde{o}}_{i}^{CG - UCI} for i = 0 , 1 , … , {O}^{CG - UCI} - 1 and A = {O}^{CG - UCI} ,$$

$$\text{?} \text{indicates text missing or illegible when filed}$$

where the CG-UCI bit sequence

$${\tilde{o}}_{0}^{CG - UCI} , {\tilde{o}}_{1}^{CG - UCI} , … , {\tilde{o}}_{{O}^{CG - UCI} - 1}^{CG - UCI}$$

is given by Table 6.3.2.1.3-1, mapped in the order from upper part to lower part.

Table 6.3.2.1.3-1 of TS 38.212 specifies the mapping order of CG-UCI fields.

TABLE 6.3.2.1.3-1
Mapping order of CG-UCI fields

| FIELD | BITWIDTH |
|---|---|
| HARQ process number | 5 if nrofHARQ-Processes-v1700 in |
| | ConfiguredGrantConfig is configured; |
| | 4 otherwise. |
| Redundancy version | 2 |
| New data indicator | 1 |
| Channel Occupancy Time | [log₂ c] if both higher layer parameter ul- |
| (COT) sharing information | toDL-COT-SharingED-Threshold and |
| | higher layer parameter cg-COT-SharingList |
| | are configured, or if both higher layer |
| | parameter |
| | semiStaticChannelAccessConfigUE and |
| | higher layer parameter cg-COT-SharingList |
| | are configured, or if higher layer parameter |
| | cg-COT-SharingList is configured in |
| | frequency range 2-2, where C is the |
| | number of combinations configured in cg- |
| | COT-SharingList; |
| | 0 otherwise. |
| | If a UE indicates COT sharing other than “no |
| | sharing” in a CG PUSCH within the UE's |
| | initiated COT, the UE should provide |
| | consistent COT sharing information in all the |
| | subsequent CG PUSCHs, if any, occurring |
| | within the same UE's initiated COT such |
| | that the same DL starting point and |
| | duration are maintained. |

### HARQ-ACK and CG-UCI (Section 6.3.2.1.4 in TS 38.212 V17.4.0 (2022-12)

Section 6.3.2.1.4 in TS 38.212 V17.4.0 also provides that when the higher layer parameter cg-UCI-Multiplexing is configured, the UCI bit sequence a₀, a₁, a₂, a₃, . . . , a_{A-1}, is determined as follows, where A=O^{CG-UCI}+O^{ACK}:
The CG-UCI bits are mapped to the UCI bit sequence a₀, a₁, a₂, a₃, . . . , a₀_{^{CG-UCI}}₋₁, where

$$\text{?} = {\tilde{o}}_{1}^{CG - UCI} for i = 0 , 1 , … , {O}^{CG - UCI} - 1.$$

$$\text{?} \text{indicates text missing or illegible when filed}$$

The CG-UCI bit sequence

$${\tilde{o}}_{0}^{CG - UCI} , {\tilde{o}}_{1}^{CG - UCI} , … , {\tilde{o}}^{CG - UCI} \text{?}$$

$$\text{?} \text{indicates text missing or illegible when filed}$$

is given by Table 6.3.2.1.3-1 mapped in the order from upper part to lower part, and O^{CG-UCI} is number of CG-UCI bits;
The HARQ-ACK bits are mapped to the UCI bit sequence a₀_{^{CG-UCI}}, a₀_{^{CG-UCI}}₊₁, . . . ,a₀_{^{CG-UCI}}₊₀_{^{ACK}}₋₁, where

$$\text{?} CG - UCI = {\tilde{o}}_{i}^{ACK}$$

$$\text{?} \text{indicates text missing or illegible when filed}$$

for i=0, 1, . . . , O^{ACK}−1. The HARQ-ACK bit sequence

$${\tilde{o}}_{0}^{ACK} , {\tilde{o}}_{1}^{ACK} , … , {\tilde{o}}^{ACK} \text{?}$$

$$\text{?} \text{indicates text missing or illegible when filed}$$

is given by Clause 9.1 of [5, TS 38.213], and O^{ACK} is number of HARQ-ACK bits.
Beta factors for CG-UCI (Section 9.3, TS 38.213, v17.4.0)

### Section 9.3 of TS 38.213, v17.4.0 Also Provides Beta Factors for CG-UCI. In More Detail:

For a PUSCH transmission that is configured by a ConfiguredGrantConfig and includes CG-UCI, the UE multiplexes CG-UCI in the PUSCH transmission if the UE is provided by betaOffsetCG-UCI a

$${I}_{offset}^{CG - UCI}$$

value, from a set of values, with the mapping defined in Table 9.3-1. If the UE is provided cg-UCI-Multiplexing and multiplexes HARQ-ACK information in the PUSCH transmission, as described in clauses 9 and 9.2.5, the UE jointly encodes the HARQ-ACK information and the CG-UCI [5, TS 38.212] and determines a number of resources for multiplexing the combined information in a PUSCH using

$${β}_{offset}^{HARQ - ACK}$$

which provides indexes

$${I}_{offset , 1}^{HARQ - ACK} and {I}_{offset , 2}^{HARQ - ACK}$$

for the UE to use if the UE multiplexes up to 11, and more than 11 combined information bits, respectively.

### Physical Layer Procedures in Section 6.3.2, TS 38.212, v17.4.0)

Section 6.3.2 of TS 38.212, v17.4.0 and its sub-sections describe the physical layer procedures for bit sequence generation, code block segmentation, channel coding, rate matching, multiplexing, etc., for UCI types (e.g., HARQ-ACK, CSI, and CG-UCI).

### New Data Indicator (NDI)

### The 3GPP Document TS 38.212, V17.4.0 (2022 December) Also Provides Information for the New Data Indicator (NDI). Particularly:

New data indicator—1 bit if the number of scheduled PUSCH indicated by the Time domain resource assignment field is 1; otherwise 2, 3, 4, 5, 6, 7 or 8 bits determined based on the maximum number of schedulable PUSCH among all entries in the higher layer parameter pusch-TimeDomainAllocationListForMultiPUSCH, where each bit corresponds to one scheduled PUSCH as defined in clause 6.1.4 in [6, TS 38.214].

### Redundancy Version (RV)

The 3GPP Document TS 38.212, V17.4.0 (2022 December), Also Provides Information Regarding the Redundancy Version (RV), Such as how the Number of Bits are Determined. Particularly:
Redundancy version—number of bits determined by the following:
   2 bits as defined in Table 7.3.1.1.1-2 if the number of scheduled PUSCH indicated by the Time domain resource assignment field is 1;
   otherwise 2, 3, 4, 5, 6, 7 or 8 bits determined by the maximum number of schedulable PUSCHs among all entries in the higher layer parameter pusch-TimeDomainAllocationListForMultiPUSCH, where each bit corresponds to one scheduled PUSCH as defined in clause 6.1.4 in [6, TS 38.214] and redundancy version is determined according to Table 7.3.1.1.2-34.

### Time Domain Resource Allocation (TDRA)

3GPP TS 38.212, V17.4.0 (2022 December), also provides information regarding the Time Domain Resource Allocation (TDRA), including information specifying the time domain resource assignment. Specifically:
Time domain resource assignment—0, 1, 2, 3, 4, 5, or 6 bits
   If the higher layer parameter pusch-TimeDomainAllocationListDCl-0-1 is not configured and if the higher layer parameter pusch-TimeDomainAllocationListForMultiPUSCH is not configured and if the higher layer parameter pusch-TimeDomainAllocationList is configured, 0, 1, 2, 3, or 4 bits as defined in Clause 6.1.2.1 of [6, TS 38.214]. The bitwidth for this field is determined as [log ₂ (I)] bits, where I is the number of entries in the higher layer parameter pusch-TimeDomainAllocationList;
   If the higher layer parameter pusch-TimeDomainAllocationListDCl-0-1 is configured or if the higher layer parameter pusch-TimeDomainAllocationListForMultiPUSCH is configured, 0, 1, 2, 3, 4, 5 or 6 bits as defined in Clause 6.1.2.1 of [6, TS 38.214]. The bitwidth for this field is determined as [log ₂(I)] bits, where/is the number of entries in the higher layer parameter pusch-TimeDomainAllocationListDCl-0-1 or pusch-TimeDomainAllocationListForMultiPUSCH;

### CG Type 2 Signaling Validation and SLIV Restrictions

3GPP TS 38.213, V17.4.0 (2022 December), which is incorporated herein by reference in its entirety, specifies how a UE validates, for scheduling activation or scheduling release, a DL SPS assignment PDCCH or a configured UL grant Type 2 PDCCH if:
the CRC of a corresponding DCI format is scrambled with a CS-RNTI provided by cs-RNTI or a G-CS-RNTI provided by g-cs-RNTI, and
the new data indicator field in the DCI format for the enabled transport block is set to ‘0’, and
the DFI flag field, if present, in the DCI format is set to ‘0’, and
the time domain resource assignment field in the DCI format indicates a row with single SLIV, and
if validation is for scheduling activation and if the PDSCH-to-HARQ_feedback timing indicator field in the DCI format is present, the PDSCH-to-HARQ_feedback timing indicator field does not provide an inapplicable value from dl-DataToUL-ACK-r16.

Additionally, this document provides the following tables (i.e., Tables 10.2-1, 10.2-2, and 10.2-3).

Table 10.2-1 specifies the special fields for single DL SPS or single UL grant Type 2 scheduling activation PDCCH validation when a UE is provided a single SPS PDSCH or UL grant Type 2 configuration in the active DL/UL BWP of the scheduled cell.

TABLE 10.2-1

| | DCI format | DCI format | DCI format |
|---|---|---|---|
| | 0_0/0_1/0_2 | 1_0/1_2/4_1 | 1_1/4_2 |
| HARQ process | set to all ‘0’s | set to all ‘0’s | set to all ‘0’s |
| number | | | |
| (if present) | | | |
| Redundancy version | set to all ‘0’s | set to all ‘0’s | For the enabled |
| (if present) | | | transport block: |
| | | | set to all ‘0’s |

Table 10.2-2 specifies the special fields for single DL SPS or single UL grant Type 2 scheduling release PDCCH validation when a UE is provided a single SPS PDSCH or UL grant Type 2 configuration in the active DL/UL BWP of the scheduled cell.

TABLE 10.2-2

| | DCI format | DCI format |
|---|---|---|
| | 0_0/0_1/0_2 | 1_0/1_1/1_2/4_1/4_2 |
| HARQ process number | set to all ‘0’s | set to all ‘0’s |
| (if present) | | |
| Redundancy version | set to all ‘0’s | set to all ‘0’s |
| (if present) | | |
| Modulation and coding | set to all ‘1’s | set to all ‘1’s |
| scheme | | |
| Frequency domain | set to all ‘0’s | set to all ‘0’s for |
| resource assignment | for FDRA Type 2 | FDRA Type 0 or for |
| | with μ = 1 | dynamicSwitch |
| | set to all ‘1’s, | set to all ‘1’s for |
| | otherwise | FDRA Type 1 |

Table 10.2-3 specifies the special fields for a single DL SPS or single UL grant Type 2 scheduling activation POOCH validation when a UE is provided multiple DL SPS or UL grant Type 2 configurations in the active OL/UL BWP of the scheduled cell.

TABLE 10.2-3

| | DCI format | DCI format | DCI format |
|---|---|---|---|
| | 0_0/0_1/0_2 | 1_0/1_2/4_1 | 1_1/4_2 |
| Redundancy | set to all ‘0’s | set to all ‘0’s | For the enabled |
| version | | | transport block: |
| (if present) | | | set to all ‘0’s |

### CG PUSCH's Retransmission

According to 3GPP TS 38.321 V17.3.0 (2022 December), which is incorporated herein by reference in its entirety, an uplink grant is either received dynamically on the POOCH, in a Random Access Response, configured semi-persistently using RRC, or determined to be associated with the PUSCH resource of MSGA as specified in clause 5.1.2a of TS 38.321. Additionally, the MAC entity shall have an uplink grant to transmit on the UL-SCH. To perform the requested transmissions, the MAC layer receives HARQ information from the lower layers. An uplink grant addressed to CS-RNTI with NDI=0 is considered as a configured uplink grant. An uplink grant addressed to CS-RNTI with NDI=1 is considered as a dynamic uplink grant.

3GPP TS 38.321 V17.3.0 (2022 December) also specifies that if the MAC entity has a C-RNTI, a Temporary C-RNTI, or CS-RNTI, the MAC entity shall, for each POOCH occasion and for each Serving Cell belonging to a TAG that has a running timeAlignmentTimer or a running cg-SDT-TimeAlignmentTimer and for each grant received for this POOCH occasion, implement the following procedures.
IF (an uplink grant for this Serving Cell has been received on the POOCH for the MAC entity's C-RNTI or Temporary C-RNTI) OR (an uplink grant has been received in a Random Access Response) THEN
IF the uplink grant is for MAC entity's C-RNTI and if the previous uplink grant delivered to the HARQ entity for the same HARQ process was either an uplink grant received for the MAC entity's CS-RNTI or a configured uplink grant THEN consider the NDI to have been toggled for the corresponding HARQ process regardless of the value of the NDI.
IF the uplink grant is for MAC entity's C-RNTI, and the identified HARQ process is configured for a configured uplink grant THEN
   start or restart the configuredGrantTimer for the corresponding HARQ process, if configured;
   stop the cg-RetransmissionTimer for the corresponding HARQ process, if running;
stop the cg-SDT-RetransmissionTimer for the corresponding HARQ process, if running; deliver the uplink grant and the associated HARQ information to the HARQ entity.
   ELSE IF an Uplink Grant for this PDCCH Occasion has been Received for this Serving Cell on the PDCCH for the MAC Entity's CS-RNTI THEN
IF the NDI in the received HARQ information is 1 THEN consider the NDI for the corresponding HARQ process not to have been toggled;
   start or restart the configuredGrantTimer for the corresponding HARQ process, if configured;
   stop the cg-RetransmissionTimer for the corresponding HARQ process, if running;
   stop the cg-SDT-RetransmissionTimer for the corresponding HARQ process, if running;
   deliver the uplink grant and the associated HARQ information to the HARQ entity;
   IF a logical channel associated with a DRB configured with survivalTimeStateSupport is multiplexed in the MAC PDU stored in the HARQ buffer for the corresponding HARQ process THEN
      trigger activation of PDCP duplication for all configured RLC entities of the DRB.
ELSE IF the NDI in the received HARQ information is 0 THEN
   IF PDCCH contents indicate configured grant Type 2 deactivation THEN trigger configured uplink grant confirmation;
   ELSE IF PDCCH contents indicate configured grant Type 2 activation THEN trigger configured uplink grant confirmation;
      store the uplink grant for this Serving Cell and the associated HARQ information as configured uplink grant;
      initialize or re-initialize the configured uplink grant for this Serving Cell to start in the associated PUSCH duration and to recur according to rules in clause 5.8.2;
      stop the configuredGrantTimer for the corresponding HARQ process, if running; and
      stop the cg-RetransmissionTimer for the corresponding HARQ process, if running.

Additionally, for each Serving Cell and each configured uplink grant, if configured and activated, the MAC entity shall perform the following procedure(s).
IF the MAC entity is configured with Ich-basedPrioritization AND the PUSCH duration of the configured uplink grant does not overlap with the PUSCH duration of an uplink grant received in a Random Access Response or with the PUSCH duration of an uplink grant addressed to Temporary C-RNTI or the PUSCH duration of a MSGA payload for this Serving Cell OR
IF the MAC entity is not configured with Ich-basedPrioritization AND the PUSCH duration of the configured uplink grant does not overlap with the PUSCH duration of an uplink grant received on the PDCCH or in a Random Access Response or the PUSCH duration of a MSGA payload for this Serving Cell THEN
   set the HARQ Process ID to the HARQ Process ID associated with this PUSCH duration;
   IF, for the corresponding HARQ process, the configuredGrantTimer is not running and cg-RetransmissionTimer is not configured and cg-SDT-RetransmissionTimer
      is not configured (i.e. a new transmission), THEN
         IF (there is an on-going CG-SDT procedure and PDCCH addressed to the MAC entity's C-RNTI has been received) OR IF there is no on-going CG-SDT procedure THEN
         consider the NDI bit for the corresponding HARQ process to have been toggled;
         deliver the configured uplink grant and the associated HARQ information to the HARQ entity.
   ELSE IF the cg-RetransmissionTimer for the corresponding HARQ process is configured and not running, then for the corresponding HARQ process THEN
      IF the configuredGrantTimer is not running, and the HARQ process is not pending (i.e. new transmission):
         consider the NDI bit to have been toggled;
         deliver the configured uplink grant and the associated HARQ information to the HARQ entity;
   ELSE IF the previous uplink grant delivered to the HARQ entity for the same HARQ process was a configured uplink grant (i.e. retransmission on configured grant) THEN
      deliver the configured uplink grant and the associated HARQ information to the HARQ entity.
ELSE IF the cg-SDT-RetransmissionTimer is configured and not running for the corresponding HARQ process;
   IF the configured uplink grant is for the initial transmission for the CG-SDT with CCCH message (i.e., initial new transmission) OR
   IF the configuredGrantTimer is not running or not configured, AND PDCCH addressed to the MAC entity's C-RNTI has been received after the initial transmission of the CG-SDT with CCCH message (i.e., a subsequent new transmission) THEN
      consider the NDI bit to have been toggled;
      deliver the configured uplink grant and the associated HARQ information to the HARQ entity.
   ELSE IF the previous uplink grant delivered to the HARQ entity for the same HARQ process was a configured uplink grant for initial transmission of CG-SDT with CCCH message or for its retransmission AND
   IF PDCCH addressed to the MAC entity's C-RNTI has not been received (i.e., retransmission for initial CG-SDT transmission) THEN
      consider the NDI bit to have not been toggled;
      deliver the configured uplink grant and the associated HARQ information to the HARQ entity.

### For Each Uplink Grant, the HARQ Entity Shall:

identify the HARQ process associated with this grant, and for each identified HARQ process by:
   IF the received grant was not addressed to a Temporary C-RNTI on PDCCH, and the NDI provided in the associated HARQ information has been toggled compared to the value in the previous transmission of this TB of this HARQ process OR
   IF the uplink grant was received on PDCCH for the C-RNTI and the HARQ buffer of the identified process is empty OR
   IF the uplink grant was received in a Random Access Response (i.e. in a MAC RAR or a fallback RAR) OR
   IF the uplink grant was determined as specified in clause 5.1.2a for the transmission of the MSGA payload OR
   IF the uplink grant was received on PDCCH for the C-RNTI in ra-ResponseWindow and this PDCCH successfully completed the Random Access procedure initiated for beam failure recovery OR
   IF the uplink grant is part of a bundle of the configured uplink grant, and may be used for initial transmission according to clause 6.1.2.3 of TS 38.214, which is incorporated herein by reference in its entirety, AND IF no MAC PDU has been obtained for this bundle THEN
      IF there is a MAC PDU in the MSGA buffer and the uplink grant determined as specified in clause 5.1.2a for the transmission of the MSGA payload was selected OR
      IF there is a MAC PDU in the MSGA buffer and the uplink grant was received in a fallbackRAR and this fallbackRAR successfully completed the Random Access procedure THEN obtain the MAC PDU to transmit from the MSGA buffer.
      ELSE IF there is a MAC PDU in the Msg3 buffer and the uplink grant was received in a fallbackRAR THEN obtain the MAC PDU to transmit from the Msg3 buffer.
      ELSE IF there is a MAC PDU in the Msg3 buffer and the uplink grant was received in a MAC RAR OR
      IF there is a MAC PDU in the Msg3 buffer and the uplink grant was received on PDCCH for the C-RNTI in ra-ResponseWindow and this PDCCH successfully completed the Random Access procedure initiated for beam failure recovery THEN
         obtain the MAC PDU to transmit from the Msg3 buffer.
         IF the uplink grant size does not match with size of the obtained MAC PDU AND
         IF the Random Access procedure was successfully completed upon receiving the uplink grant THEN
         indicate to the Multiplexing and assembly entity to include MAC subPDU(s) carrying MAC SDU from the obtained MAC PDU in the subsequent uplink transmission;
         obtain the MAC PDU to transmit from the Multiplexing and assembly entity.
ELSE IF this uplink grant is a configured grant configured with autonomousTx AND
IF the previous configured uplink grant, in the BWP, for this HARQ process was not prioritized AND
IF a MAC PDU had already been obtained for this HARQ process AND
IF the uplink grant size matches with size of the obtained MAC PDU AND
IF none of PUSCH transmission(s) of the obtained MAC PDU has been completely performed THEN consider the MAC PDU has been obtained.
ELSE IF the MAC entity is not configured with Ich-basedPrioritization OR
IF this uplink grant is a prioritized uplink grant THEN
   obtain the MAC PDU to transmit from the Multiplexing and assembly entity, if any;
IF a MAC PDU to transmit has been obtained THEN
   IF the uplink grant is not a configured grant configured with autonomousTx OR
   IF the uplink grant is a prioritized uplink grant THEN deliver the MAC PDU and the uplink grant and the HARQ information of the TB to the identified HARQ process;
      instruct the identified HARQ process to trigger a new transmission;
      IF the uplink grant is a configured uplink grant THEN
         start or restart the configuredGrantTimer, if configured, for the corresponding HARQ process when the transmission is performed if LBT failure indication is not received from lower layers;
         start or restart the cg-RetransmissionTimer, if configured, for the corresponding HARQ process when the transmission is performed if LBT failure indication is not received from lower layers.
         IF the configured uplink grant is for the initial transmission for CG-SDT with CCCH message THEN
         start or restart the cg-SDT-RetransmissionTimer, if configured, for the corresponding HARQ process when the transmission is performed.
      IF the uplink grant is addressed to C-RNTI, and the identified HARQ process is configured for a configured uplink grant THEN start or restart the configuredGrantTimer, if configured, for the corresponding HARQ process when the transmission is performed if LBT failure indication is not received from lower layers.
      IF cg-RetransmissionTimer is configured for the identified HARQ process AND
      IF the transmission is performed and LBT failure indication is received from lower layers THEN
         consider the identified HARQ process as pending
   ELSE
      flush the HARQ buffer of the identified HARQ process
ELSE (i.e. retransmission)
   IF the uplink grant received on PDCCH was addressed to CS-RNTI and if the HARQ buffer of the identified process is empty OR
   IF the uplink grant is part of a bundle and if no MAC PDU has been obtained for this bundle OR
   IF the uplink grant is part of a bundle of the configured uplink grant, and the PUSCH duration of the uplink grant overlaps with an uplink grant received in a Random Access Response (i.e. MAC RAR or fallbackRAR) or an uplink grant determined as specified in clause 5.1.2a for MSGA payload for this Serving Cell OR
   IF the MAC entity is not configured with Ich-basedPrioritization and this uplink grant is part of a bundle of the configured uplink grant, and the PUSCH duration of the uplink grant overlaps with a PUSCH duration of another uplink grant received on the PDCCH OR
   IF the MAC entity is configured with Ich-basedPrioritization and this uplink grant is not a prioritized uplink grant THEN ignore the uplink grant
   ELSE
      deliver the uplink grant and the HARQ information (redundancy version) of the TB to the identified HARQ process;
      instruct the identified HARQ process to trigger a retransmission;
      IF the uplink grant is addressed to CS-RNTI OR
      IF the uplink grant is addressed to C-RNTI, and the identified HARQ process is configured for a configured uplink grant THEN
         start or restart the configuredGrantTimer, if configured, for the corresponding HARQ process when the transmission is performed if LBT failure indication is not received from lower layers
      IF the uplink grant is a configured uplink grant THEN
         IF the identified HARQ process is pending THEN
         start or restart the configuredGrantTimer, if configured, for the corresponding HARQ process when the transmission is performed if LBT failure indication is not received from lower layers;
         start or restart the cg-RetransmissionTimer, if configured, for the corresponding HARQ process when the transmission is performed if LBT failure indication is not received from lower layers
         IF the configured uplink grant is for the retransmission of the initial transmission of the CG-SDT with CCCH message THEN start or restart the cg-SDT-RetransmissionTimer for the corresponding HARQ process when transmission is performed.
      IF the identified HARQ process is pending and the transmission is performed and LBT failure indication is not received from lower layers THEN consider the identified HARQ process as not pending.

### Multi-PUSCH

For Multi-PUSCH, 3GPP TS 38.214 V17.4.0 (2022 December), which is Incorporated Herein by Reference in its Entirety, Provides:
If pusch-TimeDomainAllocationListForMultiPUSCH in pusch-Config contains a row indicating resource allocation for two to eight contiguous PUSCHs, K2 given by k2-r16 indicates the slot where UE shall transmit the first PUSCH of the multiple PUSCHs. Each PUSCH has a separate SLIV and mapping type. The number of scheduled PUSCHs is signalled by the number of indicated valid SLIVs in the row of the pusch-TimeDomainAllocationListForMultiPUSCH signaled in DCI format 0_1.
For pusch-TimeDomainAllocationListForMultiPUSCH in pusch-Config, each PUSCH has a separate SLIV, mapping type, and K2 given by extendedK2. The number of scheduled PUSCHs is signaled by the number of indicated SLIVs in the row of the pusch-TimeDomainAllocationListForMultiPUSCH signaled in DCI format 0_1.
If a UE is configured with extendedK2 in pusch-TimeDomainAllocationListForMultiPUSCH in which one or more rows contain multiple SLIVs for PUSCH on a UL BWP of a serving cell, and the UE is indicated re-transmission of PUSCH by DCI format 0_1, where the PUSCH is correspond to a configured grant Type 1 or Type 2, the UE does not expect that the number of indicated SLIVs in the row of the pusch-TimeDomainAllocationListForMultiPUSCH by the DCI is more than one.

### NDI and RV Bits Mapping for Multi-PUSCH

### 3GPP TS 38.214 V17.4.0 (2022 December) Also States:

When the UE is scheduled with multiple PUSCHs by a DCI, as described in clause 6.1.2.1, the bits of the RV bitfield and the NDI bitfield, respectively, in the DCI are one to one mapped to the scheduled PUSCH(s) indicated by the TDRA information field with the corresponding transport block(s) in the scheduled order where the LSB bits of the RV bitfield and NDI bitfield, respectively, correspond to the last scheduled PUSCH indicated by the TDRA information field.

### XR WID Objective [RP-223502]

In the RAN plenary meeting RAN #98-e in December 2022, the following objectives were agreed upon for specifying related functionality in Release-18.

### Objective of SI or Core Part WI or Testing Part WI

One Objective is to Specify the Enhancements Related to Power Saving. For Example:
DRX support of XR frame rates corresponding to non-integer periodicities (through at least semi-static mechanisms e.g., RRC signaling) (RAN2).
   Another Objective is to Specify the Enhancements Related to Capacity. For Example:
multiple CG PUSCH transmission occasions in a period of a single CG PUSCH configuration (RAN1, RAN2);
Dynamic indication of unused CG PUSCH occasion(s) based on UCI by the UE (RAN1);
BSR enhancements including at least new BS Table(s); (RAN2);
Delay reporting of buffered data in uplink; (RAN2);
Provision of XR traffic assistance information for DL and UL (e.g. periodicity); (RAN2);
Discard operation of PDU Sets (RAN2).

Problems can arise, however, in some situations, For example, eXtended Reality (XR) data transmissions can have following characteristics.
Application data generate at constant FPS (synonymous to some periodical generation);
DL data can be jittery, but UL has optional jitter;
Packets sizes are big, but the volume may not be fixed (random or follow some distribution);
Latency is bounded (10 to few dozens of ms).

Based on the XR characteristics, 3GPP agreed to specify the following functionality for Release 18.
Enhanced DRX for power saving—this is due to the fact that packets sizes (volume) are big and arrival rate can be frequent. Further, it means that the UE may require large processing power in order to monitor DCIs for both UL and DL resource allocation, which can negatively impact the battery or power usage.
Support big packet transmission—3GPP agreed to enhance CG by adding multiple occasions per period to support big packet transmissions, which arrive periodically.

Currently, in Release 17, both initial transmission on CG and retransmission (using DCI scrambled with CS-RNTI) are restricted to single PUSCH or single SLIV. This means:
In a CG period, only one PUSCH/TO is allowed or allocated
For retransmission (with CS-RNTI), only single PUSCH retransmission is allowed even though UE is configured with multi-PUSCH TDRA table (applied for dynamic grants without CS-RNTI).

A period is defined herein as the time duration or window indicated by periodicity parameter in ConfiguredGrantConfig. In a period, a PUSCH is allocated (i.e., has an associated HARQ ID). Hence, after the end of a given period, the next period starts with same duration with a new PUSCH allocation (for which HARQ ID may be the same or different) with relatively similar repetitive resource allocation as other PUSCHs in previous periods (see FIG. 2).

A CG allocation with repeated allocation (i.e., PUSCH allocation in a defined period) where a period is defined by the parameter periodicity in ConfigureGrantConfig.

Currently, it has been agreed to define CG with multiple PUSCHs. Thus, it is important to remove any restrictions and also to define a behavior that allows a network to allocate both a CG period and retransmission (with CS-RNTI) with multiple PUSCHs or HARQ processes. The issues pertain to describing the behavior or policies related to:
NDI and RV pattern (especially for retransmission scenario);
HARQ ID determination; and
SLIV mapping to HARQ ID, NDI and RV.

Accordingly, embodiments of the present disclosure provide techniques for retransmitting data packets over multiple or group Physical Uplink Shared Channels (PUSCHs) using dynamic grant Downlink Control Information (DCI) scrambled with a Configured Scheduling-Radio Network Temporary Identifier (CS-RNTI). This advantageously allows the network nodes allocating time-frequency resources to the User Equipment (UEs) for retransmissions to reschedule multiple retransmissions using a single DCI scrambled with CS-RNTI.

Additionally, the HARQ processes (HPs) associated with multiple PUSCH retransmissions are the same HPs associated with the initial transmissions on CG resources (CG PUSCHs). In other words, according to the present disclosure, a gNB can allocate retransmissions for the same HPs using a single encoded DCI (i.e., scrambled with CS-RNTI) if the gNB failed to decode multiple PUSCHs associated with different HP IDs (each PUSCH is associate with a unique ID). The multiple PUSCHs which were initially transmitted CG resources can belong to:
multi-PUSCH CG (enhance CG in a WID), where multiple PUSCHs can be from one or more period;
existing CG (one PUSCH per CG period), where multiple PUSCHs refer to PUSCHs on multiple periods; or
multiple CGs, where PUSCHs belong to different CG IDs.

The retransmission behavior of multiple PUSCHs using dynamic grant DCI scrambled with CS-RNTI (i.e., encoded DCI), as described herein, provides a variety of benefits and advantages over current systems. For example, only a single PUSCH retransmission of CG PUSCH is currently allowed using a DCI scrambled with CS-RNTI. However, due to the upcoming support of multi-PUSCH transmissions in a CG period, the restriction on retransmissions should be removed in order to harmonize the transmission behavior for both the initial transmissions in a CG period, as well as any retransmissions. Thus, according to the present embodiments, retransmissions can be configured with multi-PUSCH allocations using encoded DCI (i.e., DCI scrambled with CS-RNTI).

The present embodiments also enhance traffic having low latency requirements. For example, XR traffic has low latency. If a given CG period for transmitting multiple PUSCHs experiences channel loss and fails, then it is likely that all the PUSCHs will also fail and require retransmissions. With conventional restrictions, each retransmission is rescheduled using a separate DCI. However, there may not be enough time to schedule each retransmission in this manner. Therefore, scheduling all retransmissions using a same encoded DCI (e.g., scrambled with CS-RNTI) makes sense.

### Retransmission of CG PUSCH

Given the above, one embodiment of the present disclosure provides a technique for rescheduling multiple TBs, that were initially transmitted by CG PUSCH, for retransmission using a single grant DCI scrambled with CS-RNTI. In other words, one DCI can allocate multiple retransmissions corresponding to multiple HARQ processes (HPs) that were used to transmit TBs on CG PUSCHs as initial transmissions.

For example, a single encoded DCI grant can be used to allocate retransmission resources for HARQ process HP 1 and HP 2 where x1 where HP 1 and HP 2 were also initially used to transmit TBs over CG resources.

In one embodiment, the multiple retransmission grants using a single encoded DCI is applicable for at least the following non-limiting configurations
If the parameter pusch-TimeDomainAllocationListForMultiPUSCH is configured, then the parameter K₂ for each schedulable PUSCH can be based on
   k2-r16 (as described in TS 38.214); and/or
   extendedK2 (as described in TS 38.214).

In one embodiment, where the PUSCH corresponds to a configured grant Type X, the UE can expect that the number of indicated SLIVs in the row of the pusch-TimeDomainAllocationListForMultiPUSCH by the DCI is more than one.
The configured grant Type X can be:
   CG Type 1; and/or
   CG Type 2.

In one embodiment, the plurality of HPs (e.g., HP 1 and HP 2) being used for retransmission using a single encoded DCI correspond to the PUSCHs initially transmitted on CG. As such, the HPs and the CG(s) may have following non-limiting relations/configurations.
The HPs can belong to same period of a multi-PUSCH CG. Thus, a multi-PUSCH period can have more than one PUSCH allocated (or multiple HPs with non-overlapping IDs in the same period);
The HPs can belong to different periods, where CG can be:
   Multi-PUSCH CG;
   Existing CG, i.e., a single PUSCH CG where a CG period is allocated with only one HP/PUSCH. This means that HP x1, for example, was initially used for transmission over CG (e.g., CG Cl) and that HP x2 was initially used for transmission with CG c2 (i.e., a different CG); and
   A combination of Multi-PUSCH CG and Existing CG.

One example of such a combination is an encoded DCI allocating retransmission grants for multiple HPs (e.g., HP 1, HP 2, and HP 3) where HPs 1 and HP 2 were used for transmission in a first CG period in a multi-PUSCH CG, and HP 3 was used for transmission in another (e.g., next) period of the same CG.

In another example, an encoded DCI can allocate retransmission grants for HP 1, HP 2, and HP 3, where HPs 1 and HP 2 were transmitted in a first period CG C1 (in multi-PUSCH CG) and HP 3 was transmitted in different period CG C2.

In one embodiment, the NDI bitfield in an encoded DCI can have the following sizes (where CG can be a multi-PUSCH CG or a legacy CG (i.e., a single-PUSCH CG). Particularly:
The size of NDI bitfield may be determined based on the maximum number of schedulable PUSCHs among all entries in the higher layer parameter pusch-TimeDomainAllocationListForMultiPUSCH, where each bit corresponds to one scheduled PUSCH as defined in clause 6.1.4 of TS 38.214. For example, consider an entry in the pusch-TimeDomainAllocationListForMultiPUSCH TDRA table indicating that the maximum number of PUSCHs/SLIVs is 5. In such cases, the NDI bitfield size is 5 regardless of how many PUSCHs are being retransmitted by DCI. Additionally, in this scenario, the maximum number of PUSCHs that can be retransmitted is 5 (based on maximum number of SLIVs configured).
The size of NDI bitfield may be the same as the size of the number of PUSCHs being considered for retransmissions using the same DCI. In these cases, if the network intends to allocate 5 retransmissions using the DCI, the NDI bitfield size is also 5.
The size of NDI bitfield may be 1, as described in more detail later.
   For Multiple Retransmissions with DCI Scrambled with CS-RNTI, there are the Following Options:
1 bit per schedulable PUSCH in RV bitfield;
2 bits per schedulable PUSCH in RV bitfield; and
r bits per schedulable PUSCH in RV bitfield.

However, if there are n schedulable PUSCHs, then RV bitfield can be of size r*n, where r=1 or r=2 or some other number. For example, in one embodiment, the size of the RV bitfield is r*m, where m is determined by the maximum number of schedulable PUSCHs among all entries in the higher layer parameter, such as the pusch-TimeDomainAllocationListForMultiPUSCH or other parameter configured for multi-PUSCH transmissions for CG. In these cases, each bit corresponds to one scheduled PUSCH (e.g., which could be defined in clause 6.1.4 in TS 38.214), and the RV is determined according to Table 7.3.1.1.2-34 of TS 38.214. The maximum number of schedulable PUSCHs can be from 2 to S. Currently, S is 8; however, according to the present disclosure, S can be configured to a higher number (e.g., S=2ⁿ where n≥3).

As an example, consider a situation with r=1, m=5, the RV bitfield is set as [10100], and the NDI bitfield set as [11010] in DCI. Further consider the RV mapping to SLIV options. First, determine the number of scheduled retransmissions. This can be determined, for example, by the NDI bitfield, which indicates the number schedulable retransmissions. In this example, the number of scheduled retransmissions is 3 (i.e., which bits are set to ‘1’. In the example above, ‘10100’ is 3). Therefore, there are 2 options that can be considered for RV mapping.

In the first option, the first q bits of the RV bitfield maps to schedulable retransmissions. In the example, number of retransmissions is 3, therefore, the first 3 bits of RV bitfield (i.e., [101]) are considered and rest of the bits (i.e., [00]) are ignored.

In the second option, the same NDI is applied to the RV bitmap. In the example above, the 1st, 2nd and 4th bit of NDI is set to ‘1’ (indicating retransmissions). Therefore, the same bit position (i.e., 1st, 2nd, and 4th bit) of RV pattern is considered. That is, given [10100] above, the first PUSCH retransmission is done with RV 1, the second PUSCH retransmission is done with RV 0, and the third PUSCH retransmission is done with RV 0.

In this example, RV bit r=1 is considered for each PUSCH/SLIV. If r is set to 2, then the RV bitfield size in the current example would be 10 (i.e., r*m) instead of 5. Further, each PUSCH can be indicated with RV (00,01,10,11) options.

In one embodiment, to allocate the retransmissions (i.e., with encoded DCI, the maximum number of SLIVs in an entry in a TDRA table TimeDomainAllocationListForMultiPUSCH can be S where S is fixed (i.e., 8) or is a larger number, e.g., 16, 32, . . . , etc.

In one embodiment, with an encoded DCI (e.g., a DCI scrambled with CS-RNTI), the value or the bits of NDI can be set according to the DCI operation. More particularly:
DCI is based on an activation and deactivation CG DCI: In this case, the NDI bit(s) value is 0 (or all 0s if bitfield >1—i.e., the NDI bit(s) are all 0s).
Single PUSCH retransmission: Case with retransmission of only one PUSCH using DCI scrambled with CS-RNTI:
   If the NDI bit value is set as 1, then retransmission of CG PUSCH on dynamically allocated resources is indicated by the DCI. Specifically:
      Where the bitfield size is 1: set the value 1 for its retransmission
      Where the bitfield size is >1 (assuming that TimeDomainAllocationListForMultiPUSCH is configured):
         all bits are set to 1; However, consider the 1st SLIV in the entry for retransmission grant's resource.
         where only one bit is set as 1 and others are set as 0s:
      This corresponds to the mapped SLIV in the entry. For example, consider an entry in in the table that contains 5 SLIVs, and that the NDI bitfield pattern indicates [00100]. This means this PUSCH is retransmitted based on resources corresponding to the 3rd SLIV from 5 total SLIVs in the entry.
         Sub-option: Set the 1st bit as 1 and the remaining bits as 0s. This means only the 1st SLIV is considered for retransmission resource from the entry. Additionally, there is only one SLIV in the entry, so the set bit ‘1’ always corresponds to that particular SLIV indicated in the entry.
         Further, where the first SLIV in the entry is used, consider the table containing 4 HPs. Further consider the NDI bitfield pattern indicating [0010]. This means that the third HP is retransmitted based on resources corresponding to the 1st SLIV from 4 total SLIVs in the entry.
Multi-PUSCH retransmission: For the case with retransmissions of more than one PUSCHs using DCI scrambled with CS-RNTI:
   DCI interpretation rule
      Bit field size >1;
      Some higher layer parameters must allow multiple retransmissions using a single encoded DCI. For example, the TDRA field in DCI can point to an entry in TDRA table configured with pusch-TimeDomainAllocationListForMultiPUSCH or equivalent TDRA table designed for CG PUSCHs.
      The NDI bits pattern can contain a mix of 1s and 0s except all 0s (i.e., an activation/deactivation DCI), where bit ‘1’ indicates that the corresponding HP is retransmitted, and bit ‘0’ indicates that the corresponding HP is not retransmitted (i.e., the corresponding HP's retransmission is ignored). Particularly, all the indicated HPs are retransmitted if all bits are 1s. If all bits are set 0, however, then the DCI is read as an activation/deactivation DCI instead of a retransmission grant DCI.
   Each bit in NDI field corresponds to a CG PUSCH HP depending on mapping policy, however, some bits can be ignored if the number of schedulable HPs are lesser than NDI bitfield size.

In one embodiment, the following combinations/options/capabilities can be designed when it comes initial transmissions on CG resource and their probable retransmissions on dynamic resources (i.e., DCI scrambled with CS-RNTI).

| | THEIR PROBABLE |
|---|---|
| | RETRANSMISSIONS ON |
| INITIAL TRANSMISSIONS | DYNAMIC RESOURCES (DCI |
| ON CG RESOURCE | SCRAMBLED WITH CS-RNTI |
| Multiple PUSCHs/TOs allocation | Multiple PUSCHs retransmissions |
| per CG period allowed as in WID | allowed with DCI- |
| Multiple PUSCHs/TOs allocation | Only single PUSCH retransmission |
| per CG period allowed as in WID | allowed with DCI |
| Multiple PUSCHs/TOs allocation | Multiple PUSCHs retransmissions |
| per CG period not allowed (i.e., | allowed with DCI |
| exiting CG, with one TO per period) | |
| Multiple PUSCHs/TOs allocation | Only single PUSCH retransmission |
| per CG period not allowed (i.e., | allowed with DCI |
| exiting CG, with one TO per period) | |

In one embodiment of the present disclosure, the relationship between NDI bits and HPs are defined. Particularly, the present embodiments provide the following.
The DCI (scrambled with CS-RNTI) indicates a single HP ID in the HP bitfield, which maps to the first bit of NDI bitfield. The remaining bits in NDI bitfield correspond to the HP that incremented its value with respect to the indicated HP in the HP bitfield. While incrementing the HP value, the value should be according to the specified rules pertaining to the max value of HP allowed, modulus rule (after crossing max value, it circles back to 0 or offset value), offset, etc.
   As an example, consider one CG configuration, which is configured for transmission with 6 HPs with an offset (i.e., harq-ProcID-Offset) value set at 10. This means that the HPs with HP ID 10 to 15 are allowed for use on CG resources. The TBs with these HP IDs can be transmitted on PUSCHs within one CG period (if 6 PUSCHs are allocated per period) or in multiple CG periods (if less than 6 PUSCHs are allocated per period) depending how many PUSCHs are configured/allocated per period. Consider an example with retransmission case for the CG PUSCH where the DCI indicates HP ID 14 in HP bitfield and NDI bitfield contains [1001]. This means that the UE is granted resources to retransmit 2 CG PUSCHs on dynamically allocated resources corresponding to HP IDs 14 and 11.
      In this embodiment, the sentence “retransmit 2 CG PUSCHs on dynamically allocated resources” means that HPs associated with the PUSCHs which were previously transmitted on CG resources (i.e., as initial transmissions) are being retransmitted on dynamic resources.
   The HP IDs 14 and 11 may be derived as follows:

$$[ 1 \to ( 14 ) , 0 \to ( 14 + 1 = 15 ) , 0 \to ( ( 15 + 1 m o d 16 ) + 10 = 10 ) , 1 \to ( 10 + 1 = 11 ) ] \qquad ( 14 )$$

In another embodiment, the indices I={i₀, i₁, . . . } of set bits in NDI field are used to determine HP ID as:

HP ID for j-th PUSCH:(HP_ID_DCI+ij)mod N,

where HP_ID_DCI is the HP ID indicated in HARQ process field in the DCI and N is the number of HP configured for PUSCH. For example, where N=16 and NDI=‘1010’ and HP_ID_DCI=8, then I={0, 2} and the indicated HP IDs are {8,10}. In this embodiment, the 0-th PUSCH corresponds to the first PUSCH.
In another solution, the HP ID field in a DCI can indicate a row in some or existing RRC table that lists the HP IDs for the corresponding SLIVs or HPs that are meant to be transmitted. Assuming the previous example with the NDI bitfield set to [1001], the indicated row in RRC table may indicate IDs in following non-limiting manner:
Option 1: Indicate IDs only for set bit ‘1’. This means that, irrespective of the size of the NDI bitfield (e.g., 4 in the given example with [1001]), the HP IDs are only indicated for bits set as 1 (which is 2 in present example—the first and last bit). Hence the row can indicate:
   [x y], i.e., HP ID x corresponds to 1st bit (set value 1) in NDI bitfield 1001 and HP ID y correspond to 4th bit in NDI bitfield;
   Assuming the NDI pattern is still [1001] but the row indicates HP IDs [x y z], then HP ID z can be ignored as there are two needed retransmissions—HP ID x and Y;
   In this rule, the assumption is that the LSB bits of the NDI bitfield (which are set ‘1’), correspond to the last HP ID in the entry of a table.
Option 2: Indicate IDs only for all possible bits. This means that, for a given NDI bitfield containing more than 1 bit, the HP IDs (in the row) are indicated for all mapped bits (sub-bullets contains some flexible rules). However, for retransmission, only the corresponding HPs are considered which map to bits set as 1 in NDI field.
   As an example, with a NDI bitfield pattern [1001], the gNB can indicate a row. For example, with HPs values [x y k r] in the row, the HP IDs x and r are considered for retransmissions.
   In another example, there can be more HP IDs indicated in the row, but the UE can ignore the remaining HP IDs if they are mapped to NDI bits. For example, with HPs values [x y k r q p] in the row, the HP IDs x and r are considered for retransmissions. HP IDs y and k correspond to bit value 0, and thus, corresponding retransmissions are ignored. HP IDs q and p have no mapping, and thus, are ignored as well.
   In another example, there can be fewer HP IDs indicated in the row compared to NDI bitfield size, provided there is a HP ID for the set bit value 1. For example, consider an NDI bitfield pattern [100100]. In this case, the gNB must indicate an entry with at least 4 HP IDs. This is because the retransmissions are needed for the mapped 1st and 4th bit of NDI pattern, Hence even if the NDI pattern is [100100], it would be sufficient to indicate (in the DCI HP fields) an entry with 4 IDs in an RRC table (e.g., [x y k r]). As such, the HP IDs x and r are considered for retransmissions.

### Regarding Embodiments on SLIV Mapping Based on 8-c

In one embodiment, the UE receives a DCI scrambled with CS-RNTI where the time-domain allocation indicates a row with N>1 SLIVs and where the NDI field have M≤N bits set to ‘1’. The UE then determines M SLIVs and transmits M PUSCHs, where the SLIV for the j-th PUSCH is the i;-th SLIV and i; is the bit-index for the j-th set bit in NDI, j=0,1, . . . For example, NDI=[1010] would indicate that the UE transmits two PUSCHs—e.g., where the first PUSCH uses the first SLIV while the second PUSCH uses second SLIV. The HP ID for the two or more PUSCHs may follow one of the example embodiments discussing the relationship between NDI bits and HPs.
In another embodiment, the SLIV is determined according to a one-to-one mapping of the bits in NDI and the SLIV index. That is, the first bit in the NDI bitfield is associated with the first SLIV, the second bit in the NDI bitfield is associated with the second SLIV, and so on.
   In some such embodiments, a value of ‘0’ in the j-th bit indicates that UE shall not transmit a PUSCH corresponding j-th SLIV. For example, NDI=‘1010’ indicates that the UE transmits only 2 PUSCHs where first use first SLIV and the second PUSCH use the third SLIV.
   In other such embodiments, where at least one bit in NDI field has the value ‘1’ and j-th bit in NDI has the value ‘0’, then the UE transmits a PUSCH using the j-th SLIV where the PUSCH comprises new data (i.e., is not a re-transmission). Hence, where a DCI for the UE's CS-RNTI and time domain allocation indicates a row with more than one SLIV, then a value ‘1’ in NDI bitfield indicates a re-transmission for the associated HP while a value ‘0’ indicate to UE that NDI shall be considered to be toggled for the associated HP. In such embodiments, the validation of CG activation or deactivation requires the NDI bitfield in a DCI to be set to all ‘0’. The UE may apply the rule if UE is not configured with RRC parameter
      “cgRetransmissionWithoutNewTransmission” (or is configured with RRC parameter “cgRetransmissionAndNewTransmission”). Such embodiments could be implemented in MAC specification as described in the following pseudocode:
      ELSE IF an uplink grant for this PDCCH occasion has been received for this Serving Cell on the PDCCH for the MAC entity's CS-RNTI:
         IF the NDI in the received HARQ information is 1 THEN consider the NDI for the corresponding HARQ process not to have been toggled;
         start or restart the configuredGrantTimer for the corresponding HARQ process, if configured;
         stop the cg-RetransmissionTimer for the corresponding HARQ process, if running;
         stop the cg-SDT-RetransmissionTimer for the corresponding HARQ process, if running;
         deliver the uplink grant and the associated HARQ information to the HARQ entity;
         IF a logical channel associated with a DRB configured with survivalTimeStateSupport is multiplexed in the MAC PDU stored in the HARQ buffer for the corresponding HARQ process THEN trigger activation of PDCP duplication for all configured RLC entities of the DRB.
         ELSE IF the NDI in the received HARQ information is 0 THEN
         IF PDCCH contents indicate configured grant Type 2 deactivation: trigger configured uplink grant confirmation.
         ELSE IF PDCCH contents indicate configured grant Type 2 activation THEN trigger configured uplink grant confirmation;
         store the uplink grant for this Serving Cell and the associated HARQ information as configured uplink grant;
         initialize or re-initialize the configured uplink grant for this Serving Cell to start in the associated PUSCH duration and to recur according to rules in clause 5.8.2;
         stop the configuredGrantTimer for the corresponding HARQ process, if running;
         stop the cg-RetransmissionTimer for the corresponding HARQ process, if running.
         ELSE
         consider the NDI to have been toggled for the corresponding HARQ process:
         start or restart the configuredGrantTimer for the corresponding HARQ process, if configured;
         stop the cg-RetransmissionTimer for the corresponding HARQ process, if running;
         stop the cg-SDT-RetransmissionTimer for the corresponding HARQ process, if running;
         deliver the uplink grant and the associated HARQ information to the HARQ entity.

In one embodiment, the UE receives a DCI scrambled with CS-RNTI where the time-domain allocation indicates a row with N>1 SLIVs and where the NDI field have M≤N bits set to ‘1’. The UE then determines M SLIVs to use for M PUSCH transmissions based on bit-index of bit set to ‘1’ in NDI field. For example, if NDI=‘1010’ then the UE determines to use first and third SLIV for the 2 PUSCH transmissions. In some example embodiments, the UE applies the above method if configured with “cgRetransmissionWithoutNewTransmission” or not configured with “cgRetransmissionAndNewTransmission”.
In some example embodiments, the RV bitfield is multi-RV e.g. [RV1 RV2. RV_maxSLIVs] and the i-th RV is associated with the i-th SLIV. In other example embodiments, the RVs is determined as that first RV is associated with the first PUSCH, the second RV is associated with the second PUSCH, and so on. For example, if NDI=‘1010’ indicates the retransmission of 2 PUSCHs, then the UE uses the first and third SLIV for respective PUSCHs while using first and second RVs for the same respective PUSCHs.

In one embodiment, the UE receives an encoded DCI where the time-domain allocation indicates a row with N>1 SLIVs and where the NDI field have M≤N bits set to ‘1’. The UE then determines M SLIVs to use for M PUSCH transmissions based on order of bits set to ‘1’. The first bit set to ‘1’ maps to first SLIV, the second bit set to ‘1’ maps to second SLIV, and so on. For example, if NDI=‘1010’ then the UE determines to use first and second SLIVs for the 2 PUSCH transmissions and the UE may use first and second RV as in the example above. In some example embodiments, the UE applies the above method if configured with “cgRetransmissionWithoutNewTransmission” or not configured with “cgRetransmissionAndNewTransmission”.

In one embodiment, the UE does not expect to receive a DCI scrambled with CS-RNTI where the time-domain allocation indicates a row with N>1 SLIVs and where the NDI field have M<N or M>N bits set to ‘1’. UE determination of used SLIVs, HP ID, and RV may follow one of the methods in previous embodiments.

To allow a multi-PUSCH re-transmission grant for CG the changes to TS 38.214 may be adopted.
If a UE is configured with extendedK2 in pusch-TimeDomainAllocationListForMultiPUSCH and not configured with <cgMultiPusch> in which one or more rows contain multiple SLIVs for PUSCH on a UL BWP of a serving cell, and the UE is indicated re-transmission of PUSCH by DCI format 0_1, where the PUSCH is correspond to a configured grant Type 1 or Type 2, the UE does not expect that the number of indicated SLIVs in the row of the pusch-TimeDomainAllocationListForMultiPUSCH by the DCI is more than one.
Note: This could be a restriction on the number of set bits in the NDI field in that they must exactly match the number of SLIVs.

In one embodiment, the present disclosure provides a common retransmission policy for PUSCHs in multi-PUSCH CG period. Particularly, in this embodiment, either all PUSCHs belonging to a given period in a multi-PUSCH CG are retransmitted, or none of the PUSCHs belonging to the given period in a multi-PUSCH CG are transmitted. This gives rise to the following two cases. If a DCI scrambled with CS-RNTI is sent, then the NDI bitfield can be set accordingly.
Case 1: The NDI bitfield size is >1. In this case, the network can formulate a policy where the 1st bit of the NDI bitfield conveys whether all or none of the PUSCHs in some period are retransmitted. The period can be identified based on HP ID of 1st PUSCH in a period which can be indicated in HP ID field in the DCI.
Case 2: The NDI bitfield size is 1. In this case, all PUSCHs in a CG period are retransmitted, and the HP ID of the 1st PUSCH can be indicated in DCI to identify the period. Hence, if bit is set 0, it's CG activation/deactivation DCI and if the bit is set 1, it means retransmission of all PUSCHs for some period.
In both cases, the TDRA field in DCI must point to row in a TDRA table indicating same number of SLIVs or more than the number of SLIVs/PUSCHs allocated in a CG period.

In one embodiment, the DCI can be a fallback DCI, a non-fallback DCI, or a new/enhanced DCI format 0_0, 0_1, 0_2, etc.

In one embodiment, when using the encoded DCI for allocating/scheduling a grant for multiple retransmissions, then retransmissions of PUSCHs are not scheduled with repetitions.

### Multi-PUSCH CG Transmission

In one embodiment, in the activation DCI for CG (Type 2), the time domain resource assignment field in the DCI format can indicate a row with more than single SLIV. This means, within a CG period, more than one PUSCHs or SLIVs can be allocated (where each SLIV correspond to resource allocation of an PUSCH).

In one embodiment, for CG Type 2, its configuration can allow the possibility of having more than 1 SLIV in a CG period.

In one embodiment, the CG type 1 RRC parameter rrc-ConfiguredUplinkGrant can be configured to provide allocation with more than one SLIV within a CG period. The parameters within rrc-ConfiguredUplinkGrant related to time and frequency domain can be configured to provide multiple SLIVs for multiple schedulable PUSCHs. In this embodiment, the same or similar parameter based on TimeDomainAllocationListForMultiPUSCH can be configured for Type 1 CG.

In one embodiment, to allocate resources for CG Type 1 or 2, the maximum number of SLIVs in an entry of a TDRA table (based on TimeDomainAllocationListForMultiPUSCH) can be S where:
S is a fixed value (i.e., 8); or
S is a larger value (e.g., 16, 32 . . . ).

### In One Embodiment, for HARQ ID Calculation:

The HARQ IDs of PUSCHs in a multi-PUSCH CG period with M PUSCHs allocated (per period) is derived based on some agreed formulae.
   The value M can be number of SLIVs indicated in the row of TDRA table which can be mentioned in DCI's TDRA field (for type 2 CG activation DCI) or indicated in RRC configuration (for Type 1 CG);
   The value M can be number of SLIVs indicated in the row of TDRA table which can be mentioned in DCI's TDRA field (for type 2 CG activation DCI) or indicated in RRC configuration (for Type 1 CG), and are confined within a period of the CG.
As an example, the HARQ ID derivation formulae specified in TS 38.321, which is incorporated herein by reference in its entirety, and modify it by taking account M HARQ processes/PUSCHs per period instead of 1 PUSCH per period in existing specification.
Further, the HARQ ID calculation will have 2 aspects:
   The modified formula will give HARQ ID of 1st PUSCH or first HP allocated in the period, say HP ID #H; and
   For remaining PUSCHs, their HP IDs will be incremented after HP ID #H.
The modified HARQ ID calculation formulae will be:

HARQ Process ID of 1st PUSCH in a period=[floor(CURRENT_symbol*M/periodicity)]modulo nrofHARQ-Processes;

HARQ Process ID of 1st PUSCH in a period=[floor(CURRENT_symbol*M/periodicity)]modulo nrofHARQ-Processes+harq-ProcID-Offset2
As an example:
   A CG with 15 KHZ SCS numerology has period of 2 slots (i.e., 28 symbols), which has M=4 PUSCHs allocated per CG period, which is from sym0 to sym2 for PUSCH #1, sym3 to sym5 for PUSCH #2, sym6 to sym8 for PUSCH #3 and sym9 to sym11 for PUSCH #4 in the 1st slot in a CG period. In this case, it is assumed that the slot with PUSCH allocations is an odd slot. The even slot in a period has no PUSCH allocation.
   The HARQ IDs are calculated for PUSCHs in a period X, which falls in slot number 2 and 3, and next period, i.e., X+1 (slot number 4 to slot 5) in SFN 2. The slots are numbered 0 to 13, and SFN are numbered 0 to 1023. The HARQ ID of 1st PUSCH is calculated and assume that the CG can have a maximum of 16 HARQ IDs (0 to 15).
      The HARQ ID of the 1st PUSCH in period X=[floor((2*10*14+2*14+0)*4/(2*14))]mod 16=12. Then the HARQ ID of the 2nd, 3^{rd}, and 4th PUSCH in the period will be 12+1=13, 13+1=14 and 14+1=15.
      The HARQ ID of the 1st PUSCH in period X+1=[floor((2*10*14+4*14+0)*4/(2*14))]mod 16=0. Then, the HARQ ID of the 2nd, 3^{rd}, and 4th PUSCH in the period will be 1, 2 and 3.
      As can be determined, the IDs from 2 consecutive periods do not overlap.

In one embodiment, the frequency hopping pattern is applied to multi-PUSCH CG and the text of TS 38.214, Section 6.3.1 can be modified in the specification accordingly. In one embodiment, for example, one of two frequency hopping modes can be configured. These modes are:
Intra-slot frequency hopping, applicable to single slot and multi-slot configured PUSCH transmission, multi-slot PUSCH transmission scheduled by DCI format 0_1 or 0_2, each of multiple PUSCH transmissions scheduled by a DCI if the higher layer parameter pusch-TimeDomainAllocationListForMultiPUSCH is configured and each of multiple configured grant PUSCH transmissions in a configuration where the higher layer parameters cg-nrofSlots and cg-nrofPUSCH-InSIot are provided.
Inter-slot frequency hopping, applicable to multi-slot PUSCH transmission.

In one embodiment, if the Type 1 CG or Type 2 CG are configured as multi-PUSCH CG, then PUSCHs are not allowed to transmit with their repetitions. This means that repetitions cannot be configured for such PUSCHs or the repetition factor (k) is set 1.

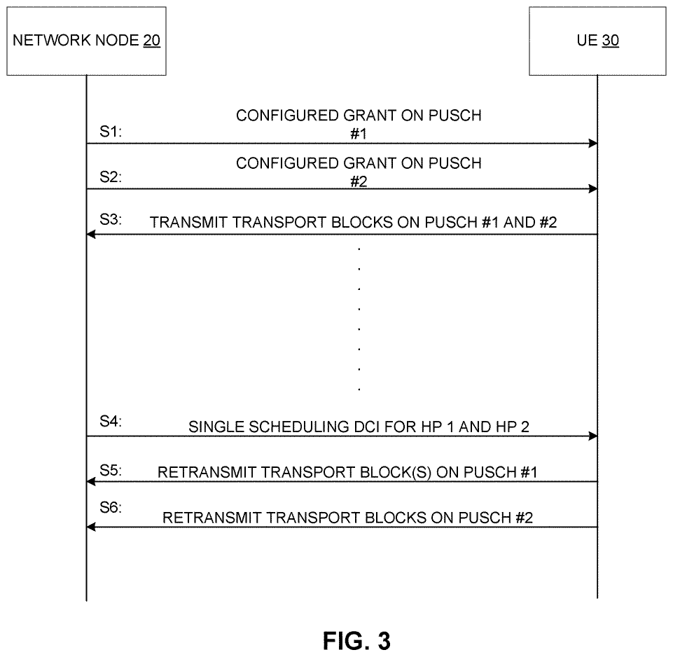

FIG. 3 is a signaling diagram illustrating signaling between network node 30 and UE 20 according to an embodiment of the present disclosure. As seen in FIG. 3, network node 30 provides UE 30 with a CD on PUSCH #1 and on PUSCH #2 (Steps S1 and S2). So obtained, UE 20 transmits data packets (i.e., TBs) on both PUSCH #1 and on PUSCH #2 (Step S3). At some point, channel conditions degrade, and therefore, UE 30 has to retransmit TBs. In this case, network node 30 sends a single encoded scheduling DCI for HP 1 and HP 2 to UE 30 (Step S4). The scheduling DCI is, as previously described, an encoded DCI (i.e., a DCI scrambled with CS-RNTI). Responsive to receiving the encoded DCI, UE 30 retransmits the TBs on PUSCH #1 and on PUSCH #2, as previously described (Steps S5 and S6). As noted above, the HPs (i.e., HP 1 and HP 2) are associated with PUSCH #1 and PUSCH #2, respectively, and are the same HPs that were used for the initial transmission of the TBs (i.e., in Step S3).

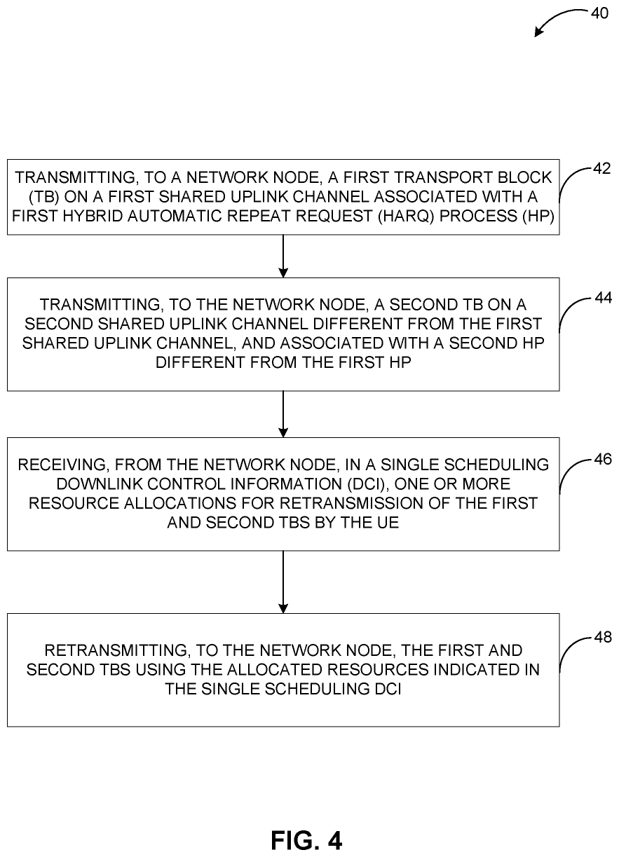

FIG. 4 is a flow diagram illustrating a method 40, implemented at UE 30, for scheduling retransmissions in a communications network according to an embodiment of the present disclosure. As seen in FIG. 4, UE 30 transmits, to a network node, a first transport block (TB) on a first shared uplink channel associated with a first Hybrid Automatic Repeat Request (HARQ) process (HP) (box 42). UE 30 also transmits, to the network node, a second TB on a second shared uplink channel different from the first shared uplink channel, and associated with a second HP different from the first HP (box 44). UE 30 then receives, from the network node, in a single scheduling Downlink Control Information (DCI) (i.e., an encoded DCI as described above), a resource allocation (e.g., one or more resource allocations) for retransmission of the first and second TBs by the UE (box 46). UE 30 then retransmits, to the network node, the first and second TBs using the allocated resources indicated in the single scheduling DCI (box 48).

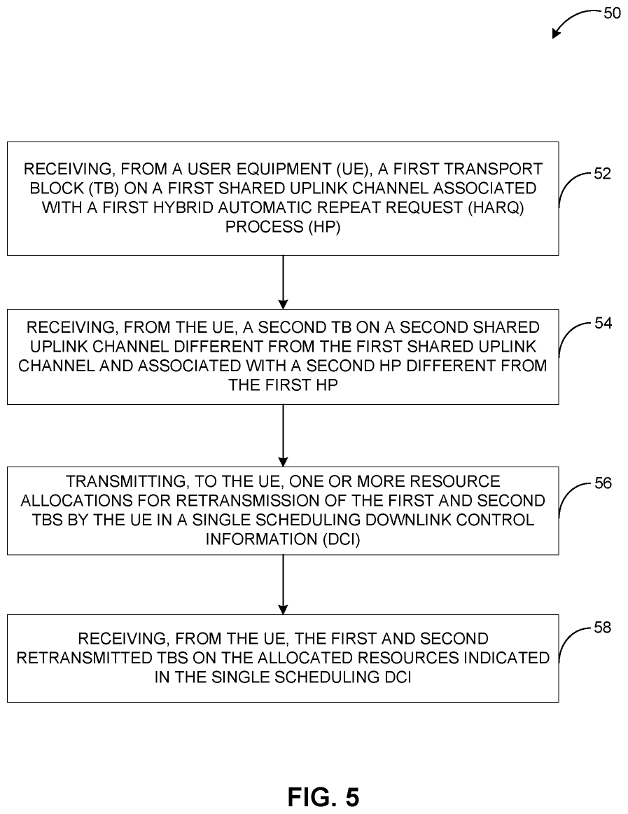

FIG. 5 is a flow diagram illustrating a method 50, implemented at network node 20, for scheduling retransmissions in a communications network according to another embodiment of the present disclosure. As seen in FIG. 5, network node 20 receives, from a UE 30, a first TB on a first shared uplink channel associated with a first HP process (box 52). Network node 20 also receives, from the UE 30, a second TB on a second shared uplink channel different from the first shared uplink channel and associated with a second HP different from the first HP (box 54). Network node 20 then transmits, to the UE 30, a resource allocation for retransmission of the first and second TBs by UE 30 in a single scheduling Downlink Control Information (DCI) (box 56). Then, network node 20 receives, from the UE 30, the first and second retransmitted TBs on the allocated resources indicated in the single scheduling DCI.

In one embodiment, the single scheduling DCI is scrambled with a Configured Scheduling Radio Network Temporary Identifier (CS-RNTI).

In one embodiment, the first and second shared uplink channels correspond to respective Configured Grant (CG) types, and the single scheduling DCI comprises a plurality of Start and Length Indicator Values (SLIVs).

In one embodiment, the CG types comprise one of CG Type 1 and CG Type 2.

In one embodiment, the first and second HPs correspond to the first and second shared uplink channels, respectively.

In one embodiment, the first and second HPs belong to a same period of the first and second shared uplink channels.

In one embodiment, the first and second HPs belong to different periods of the first and second shared uplink channels.

In one embodiment, the single scheduling DCI comprises a New Data Indicator (NDI) bitfield.

In one embodiment, a size of the NDI bitfield is determined based on a maximum number of schedulable shared uplink channels with each bit in the NDI bitfield corresponding to one of the schedulable shared uplink channels, or is the same as the number of shared uplink channels being considered for retransmissions using the same single scheduling DCI, or is 1.

In one embodiment, for multiple retransmissions using the single scheduling DCI, a Redundancy Version (RV) bitfield comprises 1 bit per schedulable shared uplink channel.

In one embodiment, for multiple retransmissions using the single scheduling DCI, a Redundancy Version (RV) bitfield comprises multiple bits per schedulable shared uplink channel.

In one embodiment, a maximum number of SLIVs in an entry of a Time Domain Resource Allocation (TDRA) table is fixed.

In one embodiment, a maximum number of SLIVs in an entry of a TDRA table is configurable.

In one embodiment, a maximum number of SLIVs in an entry of a TDRA table is 2ⁿ where n≥3.

In one embodiment, bit values of the NDI bitfield are set based on an operation of the single scheduling DCI. In such embodiments, the operation comprises one of activation of the single scheduling DCI, deactivation of the single scheduling DCI, single shared uplink channel retransmission, and multi-shared uplink channel retransmission.

In one embodiment, when the single scheduling DCI indicates a single HP, a first bit of the NDI bitfield maps to a single HP Identifier (ID) in a HP bitfield.

In one embodiment, each of the remaining bits of the NDI bitfield maps to a corresponding HP ID in the HP bitfield.

In one embodiment, the HP IDs in the HP bitfield are set according to indices of set bits in the NDI bitfield field.

In one embodiment, the HP ID in the HP bitfield in the single scheduling DCI indicates a row a Radio Resource Control (RRC) table that lists the HP IDs for corresponding SLIVs, or for HPs that are to be transmitted.

In one embodiment, a time-domain allocation in the single scheduling DCI indicates N>1 SLIVs, and wherein the NDI bitfield comprises N s M bits that are set to 1.

In one embodiment, the UE determines M SLIVs and transmits on M shared uplink channels. In such embodiments, the SLIV for a j^{th} shared uplink channel is an ij^{th} SLIV and ij is a bit-index for the jₜₕ set bit in the NDI bitfield with j=0, 1, . . . n.

In one embodiment, the SLIV is determined according to a one-to-one mapping of the bits in the NDI bitfield and an SLIV index.

In one embodiment, the UE determines M SLIVs to use for M shared uplink channel transmissions based on a bit-index of a bit set to ‘1’ in the NDI bitfield.

In one embodiment, the UE determines M SLIVs to use for M shared uplink channel transmissions based on an order of bits that are set to ‘1’ in the NDI bitfield.

In one embodiment, the UE does not expect to receive the single scheduling DCI and a time-domain allocation in the single scheduling DCI indicates N>1 SLIVs. In such embodiments, the NDI bitfield comprises N<M bits or N>M bits that are set to 1.

In one embodiment, all shared uplink channels belonging to a same period in a multi-shared channel CG are retransmitted, or none of the shared uplink channels belonging to the same period in the multi-shared channel CG are retransmitted.

In one embodiment, the single scheduling DCI comprises one of a fallback DCI, a non-fallback DCI, and an enhanced DCI.

In one embodiment, the first and second TBs scheduled for retransmission on the first and second shared uplink channels, respectively, are not scheduled to be repeated.

In one embodiment, the shared uplink channels are Physical Uplink Shared Channels (PUSCHs).

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory.

For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

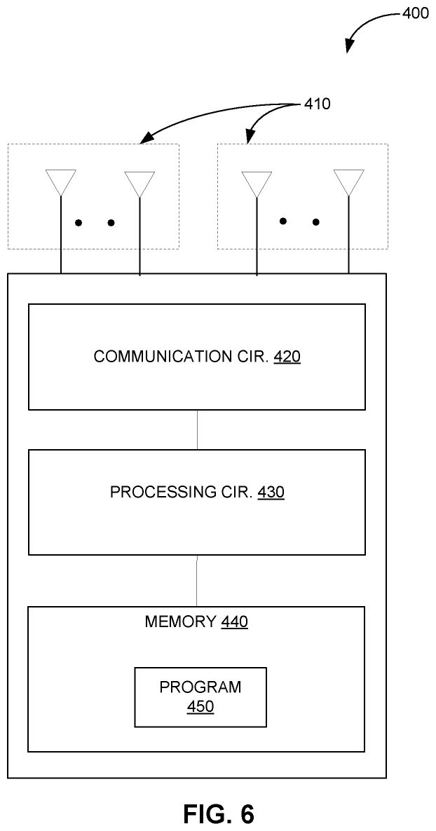

FIG. 6 illustrates the main functional components of a UE 400 (such as UE 30 previously described, for example) configured for retransmitting Transport Blocks (TBs) to a network node 20 according to an embodiment of the present disclosure. The UE 400 includes an antenna panel or antenna array comprising a plurality of antennas 410, communication circuitry 420, processing circuitry 430, and memory 440.

The communication circuitry 420 connects to the antennas 410 and comprises radio frequency (RF) circuitry 422 for communicating over a wireless communication link with multiple TRPs in a wireless communication system. The RF circuitry may comprise, for example, a transmitter and receiver configured to operate according to the 5G standards or other wireless communication standard. In exemplary embodiments, the RF circuitry includes two or more receiver chains for receiving signals transmitted from spatially separated TRPs.

The processing circuitry 430 comprises one or more microprocessors, hardware, firmware, or a combination thereof that control the overall operation of the UE 400. The processing circuitry 430 can be configured by software to perform the methods herein described including the method 40 shown in FIG. 4.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage. Memory 440 stores a computer program 450 comprising executable instructions that configure the processing circuit 430 in the UE 400 to perform the methods herein described including the method 40 shown in FIG. 4. A computer program 450 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

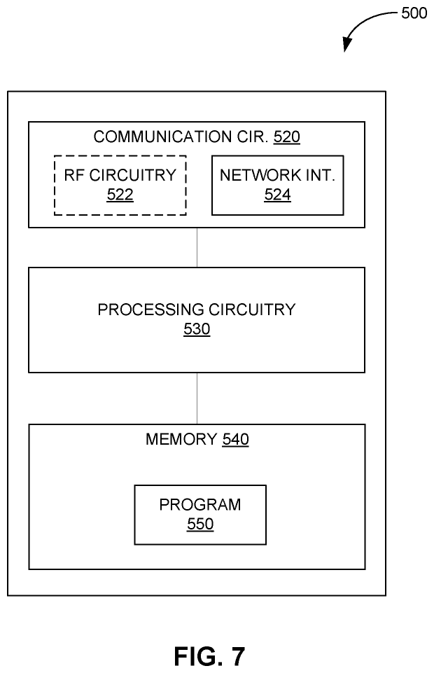

FIG. 7 illustrates the main functional components of a RAN node 500 (e.g., the network node 20 previously described), which by way of example, may comprise a base station, distributed unit, centralized unit, or other RAN node. The RAN node 500 comprises communication circuitry 520, processing circuitry 530, and memory 540.

In some embodiments, the communication circuitry 520 comprises both radio frequency (RF) circuitry 522 and network interface circuitry (NIC) 524. In other embodiments, the network node may comprise only NIC 424. The RF circuitry 422 can be located at one or more TRPs and comprises the RF components necessary for communicating with UEs over a wireless communication link. The RF circuitry may comprise, for example, a transmitter and receiver configured to operate according to the 5G standards or other wireless communication standard. The interface circuitry 520 comprises network interface circuitry for communication with other RAN nodes, core network nodes, and or external systems. The network interface circuitry may, for example, comprise an Ethernet interface, optical network interface, or a wireless interface.

The processing circuitry 530 comprises one or more microprocessors, hardware, firmware, or a combination thereof that controls the overall operation of the RAN node 500. The processing circuitry 530 can be configured by software to perform one or more of the methods herein described including method 50 as shown in FIG. 5.

Memory 540 comprises both volatile and non-volatile memory for storing computer program code and data needed by the processing circuitry 530 for operation. Memory 540 may comprise any tangible, non-transitory computer-readable storage medium for storing data including electronic, magnetic, optical, electromagnetic, or semiconductor data storage. Memory 540 stores a computer program 550 comprising executable instructions that configure the processing circuit 530 in the network node 500 to perform one or more of the methods herein described including method 50 as shown in FIG. 5. A computer program 550 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 550 for configuring the processing circuitry 530 as herein described may be stored in a removable memory, such as a portable compact disc, portable digital video disc, or other removable media. The computer program 550 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

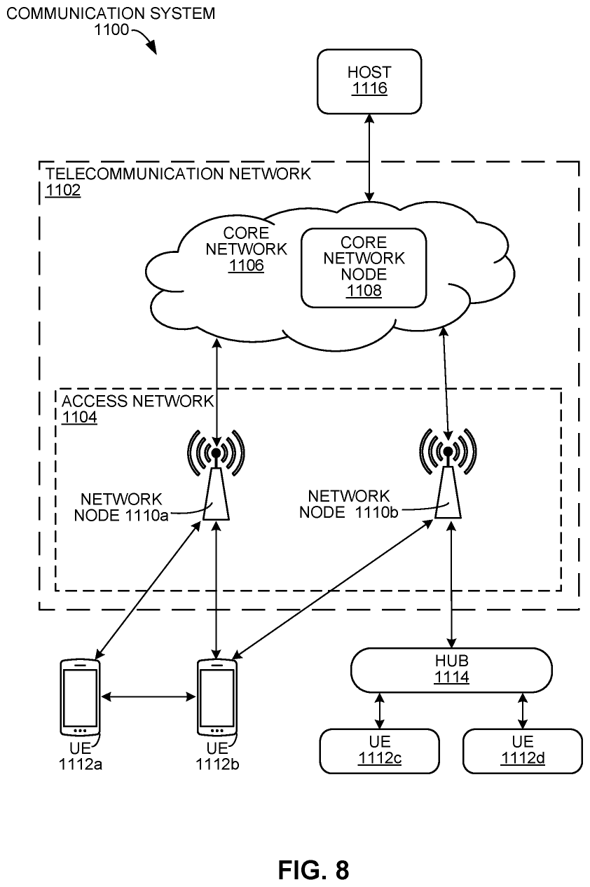

FIG. 8 shows an example of a communication system 1100 in accordance with some embodiments. In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

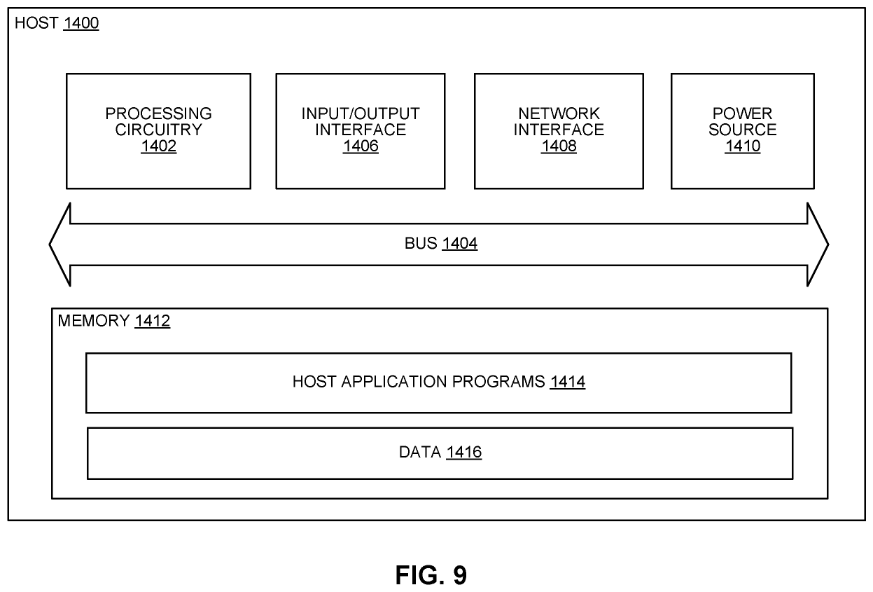

FIG. 9 is a block diagram of a host 1400, which may be an embodiment of the host 1116 of FIG. 8, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

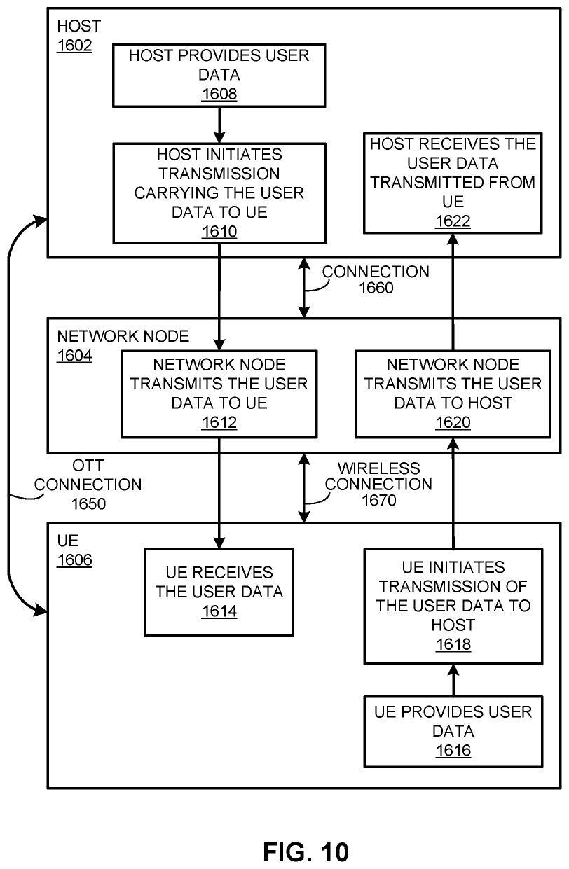

FIG. 10 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 8), network node (such as network node 1110a of FIG. 8), and host (such as host 1116 of FIG. 8) discussed in the preceding paragraphs will now be described with reference to FIG. 10.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 10) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may enable the UE to adapt faster to radio conditions and realize higher data throughput. In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The present embodiments may, of course, be carried out in other ways than those specifically set forth herein without departing from characteristics described herein. The present embodiments are therefore to be considered in all respects as illustrative and not restrictive, and all changes coming within the meaning and equivalency range of the appended claims are intended to be embraced therein.

1.-44. (canceled)

45. A method for scheduling retransmissions in a communications network, the method implemented at a User Equipment (UE) and comprising:
transmitting, from the UE to a network node, a first transport block (TB) on a first shared uplink channel associated with a first Hybrid Automatic Repeat Request (HARQ) process (HP);
transmitting, from the UE to the network node, a second TB on a second shared uplink channel that is different from the first shared uplink channel and that is associated with a second HP different from the first HP;
receiving, by the UE, from the network node, in a single scheduling Downlink Control Information (DCI), one or more resource allocations for retransmission of the first and second TBs by the UE; and
retransmitting, from the UE to the network node, the first and second TBs using the one or more allocated resources indicated in the single scheduling DCI.

46. A User Equipment (UE) configured to retransmit data on multiple uplink shared channels according to a Configured Grant (CG), the UE comprising:
processing circuitry; and
memory circuitry configured to store instructions executable by the processing circuitry whereby the UE is configured to:
transmit, to a network node, a first transport block (TB) on a first shared uplink channel associated with a first Hybrid Automatic Repeat Request (HARQ) process (HP);
transmit, to the network node, a second TB on a second shared uplink channel different from the first shared uplink channel, and associated with a second HP different from the first HP;
receive, from the network node, in a single scheduling Downlink Control Information (DCI), one or more resource allocations for retransmission of the first and second TBs by the UE; and
retransmit, to the network node, the first and second TBs using the allocated resources indicated in the single scheduling DCI.

47. The UE of claim 46, wherein the single scheduling DCI is scrambled with a Configured Scheduling Radio Network Temporary Identifier (CS-RNTI).

48. The UE of claim 46, wherein the first and second shared uplink channels correspond to respective Configured Grant (CG) types, and wherein the single scheduling DCI comprises a plurality of Start and Length Indicator Values (SLIVs).

49. The UE of claim 48, wherein the CG types comprise one of CG Type 1 and CG Type 2.

50. The UE of claim 46, wherein the first and second HPs correspond to the first and second shared uplink channels, respectively.

51. The UE of claim 46, wherein the single scheduling DCI comprises a New Data Indicator (NDI) bitfield.

52. The UE of claim 51, wherein a size of the NDI bitfield:
is determined based on a maximum number of schedulable shared uplink channels with each bit in the NDI bitfield corresponding to one of the schedulable shared uplink channels; or
is the same as a number of shared uplink channels being considered for retransmissions using the same single scheduling DCI; or
is 1.

53. The UE of claim 51, wherein bit values of the NDI bitfield are set based on an operation of the single scheduling DCI, and wherein the operation comprises one of:
activation of the single scheduling DCI;
deactivation of the single scheduling DCI;
single shared uplink channel retransmission; and
multi-shared uplink channel retransmission.

54. The UE of claim 51, wherein, when the single scheduling DCI indicates a single HP, a first bit of the NDI bitfield maps to a single HP Identifier (ID) in a HP bitfield.

55. The UE of claim 54, wherein each of one or more remaining bits of the NDI bitfield maps to a corresponding HP ID in the HP bitfield.

56. The UE of claim 54, wherein HP IDs in the HP bitfield are set according to indices of set bits in the NDI bitfield.

57. The UE of claim 54, wherein the HP ID in the HP bitfield in the single scheduling DCI indicates a row a Radio Resource Control (RRC) table that lists the HP IDs for corresponding SLIVs, or for HPs that are to be transmitted.

58. The UE of claim 51, wherein a time-domain allocation in the single scheduling DCI indicates N>1 SLIVs, and wherein the NDI bitfield comprises N s M bits that are set to 1.

59. The UE of claim 58, wherein the UE determines M SLIVs and transmits on M shared uplink channels, and wherein;
the SLIV for a j^{th} shared uplink channel is an iⱼ^{th} SLIV; and
i; is a bit-index for the j^{th} set bit in the NDI bitfield with j=0,1, . . . n.

60. The UE of claim 58, wherein the SLIV for the j^{th} shared uplink channel is determined according to a one-to-one mapping of the bits in the NDI bitfield and an SLIV index.

61. The UE of claim 58, wherein the UE determines M SLIVs to use for M shared uplink channel transmissions based on a bit-index of a bit set to ‘1’ in the NDI bitfield.

62. The UE of claim 58, wherein the UE determines M SLIVs to use for M shared uplink channel transmissions based on an order of bits that are set to ‘1’ in the NDI bitfield.

63. The UE of claim 51, wherein the UE does not expect to receive the single scheduling DCI, and wherein a time-domain allocation in the single scheduling DCI indicates N>1 SLIVs, and wherein the NDI bitfield comprises N<M bits or N>M bits that are set to 1.

64. The UE of claim 46, wherein:
all shared uplink channels belonging to a same period in a multi-shared channel CG are retransmitted; or
none of the shared uplink channels belonging to the same period in the multi-shared channel CG are retransmitted.

65. The UE of claim 46, wherein the first and second TBs scheduled for retransmission on the first and second shared uplink channels, respectively, are not scheduled to be repeated.

66. The UE of claim 46, wherein the shared uplink channels are Physical Uplink Shared Channels (PUSCHs).

67. The UE of claim 46, wherein a maximum number of SLIVs in an entry of a TDRA table is configurable.

68. The UE of claim 46, wherein a maximum number of SLIVs in an entry of a TDRA table is 2ⁿ where n≥3.

69. A method for scheduling retransmissions in a communications network, the method implemented at a network node and comprising:
receiving, by the network node, from a User Equipment (UE), a first transport block (TB) on a first shared uplink channel associated with a first Hybrid Automatic Repeat Request (HARQ) process (HP);
receiving, by the network node, from the UE, a second TB on a second shared uplink channel that is different from the first shared uplink channel and that is associated with a second HP different from the first HP;
transmitting, from the network node to the UE, in a single scheduling Downlink Control Information (DCI), one or more resource allocations for retransmission of the first and second TBs by the UE; and
receiving, by the network node, from the UE, the first and second retransmitted TBs on the one or more allocated resources indicated in the single scheduling DCI.

70. A network node for scheduling retransmissions in a communications network, the network node comprising:
processing circuitry; and
memory circuitry configured to store instructions executable by the processing circuitry whereby the network node is configured to:
receive, from a User Equipment (UE), a first transport block (TB) on a first shared uplink channel associated with a first Hybrid Automatic Repeat Request (HARQ) process (HP);
receive, from the UE, a second TB on a second shared uplink channel different from the first shared uplink channel and associated with a second HP different from the first HP;
transmit, to the UE, one or more resource allocations for retransmission of the first and second TBs by the UE in a single scheduling Downlink Control Information (DCI); and
receive, from the UE, the first and second retransmitted TBs on the allocated resources indicated in the single scheduling DCI.
